(19) United States
(12) Patent Application Publication
(10) Pub. No.: US 2026/0259561 A1
(43) Pub. Date: Sep. 3, 2026

(54) VIRTUAL SAFETY GATE

(71) Applicant: Bastian Solutions, LLC, Carmel, IN (US)

(72) Inventors: Michael Marcum, Georgetown, KY (US); Allen Flath, Lexington, KY (US)

(73) Assignee: Bastian Solutions, LLC, Carmel, IN (US)

(21) Appl. No.: 19/068,672

(22) Filed: Mar. 3, 2025

(51) Int. Cl. G05D 1/225; B65G 67/00; B66F 9/06; B66F 9/075; G05D 1/227; G05D 101/00; G05D 105/28

(52) U.S. Cl. CPC G05D 1/225; B65G 67/00; B66F 9/063; B66F 9/0755; G05D 1/2272; G05D 2101/22; G05D 2105/28

(57) ABSTRACT

A virtual safety gate configured to protect human workers from autonomous vehicles in manufacturing, warehousing, and/or other types of facilities. In one version, the virtual safety gate is particularly adapted to protect human workers that enter a trailer at a loading dock. The virtual safety gate monitors the trailer and determines whether the vehicle is allowed to enter the trailer. If the conditions are not safe, the virtual safety gate stops the vehicle. The virtual safety gate includes a vehicle module on each vehicle and a dock module at each loading dock. The dock modules and vehicle modules are universally interfaceable and are configured to install on existing equipment. The vehicle modules and dock modules communicate using wireless data transmission devices, such as optical couplers.

### BACKGROUND

Robots are commonly implemented to perform various tasks such as stacking, unstacking, loading, unloading, and/or transporting items in a warehouse or manufacturing facility. Such facilities oftentimes utilize both humans and robots in the same working areas. Direct interactions between humans and robots can result in serious harm to humans. For example, there is a risk of human workers being injured and/or trapped by robots, such as autonomous vehicles, in loading areas, storage areas, and/or other confined spaces. Robust safety measures should be used to prevent such interactions and to protect human workers. Such safety measures may not be practical to implement and/or may not be fully effective in various settings.

Thus, there is a need for improvement in this field.

### SUMMARY

In many types of facilities, such as manufacturing plants, warehouses, and/or shipping centers as examples, humans work near vehicles, robots, and/or other heavy machinery. For example, such facilities utilize robotic or autonomous vehicles and/or human-driven robots. In one particular example, the vehicle is in the form of a forklift that is used at a loading dock to load and/or unload items from trailers. These vehicles, robots, and/or other equipment generally pose a risk to human workers to cause serious injury if the human is struck, trapped, or contacted in another way. The risk is particularly high in confined spaces such as in the trailer. For instance, there is a risk for the vehicle to crush and/or trap the human worker in the trailer. To ensure safety of the human workers, the vehicles typically must be separated from the humans. Many traditional safety measures rely on a physical gate to separate the human workers and the vehicles when the human enters the trailer. However, physical gates are not always reliable. For instance, the vehicle may still follow and injure the human workers when the gate is left open. Some safety systems further utilize a scanner on the vehicle to monitor the area for human workers. However, the scanner oftentimes becomes obstructed, such as by the forks on a forklift and/or by large items being carried by the forklift. In such scenarios, the human worker is at risk because the scanner cannot reliably detect the human worker.

A unique virtual safety gate has been developed to protect human workers from vehicles, robots, and/or other machinery in a variety of settings. The virtual safety gate monitors an area where both humans and vehicles, robots, and/or other machinery have access. The monitored area is typically a confined space where the risk of collision and/or injury is high. In one version, the virtual safety gate protects humans from forklifts at a loading dock. For example, the monitored area is the space inside a trailer at the loading dock. The virtual safety gate is configured to protect other forklifts, robots, and/or equipment from damage in the same way as the human worker. When the virtual safety gate detects that the monitored area is clear from human workers, the forklift is allowed to enter. Otherwise, the virtual safety gate commands the forklift to stop until conditions are safe. Stopping the forklift ensures that human worker is safe from being crushed, trapped, and/or injured in other ways. As noted, the forklift oftentimes carries items that fully or partially block one or more scanners on the forklift. The virtual safety gate typically allows the forklift to rely on the scanners when the scanners are not obstructed. However, the virtual safety gate monitors the area for the human worker when at least one of the scanners is obstructed. Unlike many traditional safety measures, the virtual safety gate provides constant surveillance and protection for the human workers.

The virtual safety gate is designed to operate at a high safety level. In one version, the virtual safety gate operates at performance level (PL) d or higher. Performance level is a rating for machinery controls established by ISO 13849. The rating scale ranges from PLa to PLe, with PLe being the highest safety rating. To operate within the PLd rating, the probability of a dangerous failure occurring per hour must be between 0.00001% and 0.000001%. Performance level is further determined based on the type of harm that is protected against. The virtual safety gate protects against serious harm or death that the human workers are otherwise unlikely to avoid. The virtual safety gate meets PLd requirements by protecting against such harm.

Further, the virtual safety gate follows Category 3 safety architecture or higher. ISO 13849 additionally defines multiple architecture categories, ranging from B to 4, with 4 having the highest safety measures. Category B architecture utilizes average-quality components without fail-safes or component monitoring. Category 3 architecture involves using multiple fail-safes and periodically assessing the of functionality of components.

The virtual safety gate generally includes a dock subsystem and a vehicle subsystem. The dock subsystem is installed at the loading dock, and the vehicle subsystem is installed on the forklift. The dock subsystem at the loading dock pairs with the vehicle subsystem on the forklift to form the complete virtual safety gate. The virtual safety gate is designed to be installed on existing equipment. This allows facility owners and operators to implement the virtual safety gate without having to completely replace existing equipment. The dock and vehicle subsystems are also universally interfaceable. This allows a dock subsystem installed at one loading dock to seamlessly interface with the vehicle subsystem on any forklift that approaches that loading dock. Further, the dock and vehicle subsystems work reliably across any pair of forklift and loading dock.

The dock subsystem and the vehicle subsystem communicate via data transmission devices on the forklift and on the dock. The dock subsystem includes a dock coupler. The vehicle subsystem includes a vehicle coupler. In one version, the dock coupler and the vehicle coupler are optical couplers that send and/or receive signals in the form of pulses of light. In one particular example, the optical couplers are 8-bit optical couplers that communicate through multiple channels simultaneously. The dock subsystem uses the dock coupler to communicate the safety status of the loading dock and monitored area to the vehicle subsystem. The dock coupler and the vehicle coupler are universally interfaceable. Any forklift with the vehicle coupler is able to communicate effectively with the dock coupler at any loading dock.

The dock subsystem typically further includes a controller, a sensor, a manual input device, and an indicator. The controller is communicatively connected to the other components in the dock subsystem. The sensor observes the entrance to the monitors area, such as the entrance to the trailer. The virtual safety gate uses the sensor to detect when the human operator enters the monitored area. In one example, the sensor is a light beam sensor that produces a light curtain across the trailer entrance. The manual input device allows the human operator to manually reset the virtual safety gate after the forklift is stopped. The input device includes a button, switch, voice command module, badge reader, and/or other devices. The virtual safety gate waits for a reset input before restarting to ensure that the human operator manually inspects the monitored area first. The indicator provides feedback to the human operator and/or other systems that the forklift has been stopped and/or that the conditions are unsafe.

The vehicle subsystem further includes a vehicle manager, an entry zone detector, and the scanner. The vehicle manager includes a computer and/or a controller. The vehicle manager controls the components in the vehicle subsystem. In one version, the vehicle manager stores and executes all the safety logic for the virtual safety gate. The entry zone detector is used to detect that the forklift in at the entrance to the monitored area. In one version, the entry zone detector includes a plate detector that detects a dock plate leading to the trailer. The virtual safety gate utilizes the plate detector to check the position of the forklift near the trailer. When the plate detector senses the dock plate, the virtual safety gate evaluates the safety status of the monitored area before allowing the forklift to enter. The scanner monitors the area around the forklift. The virtual safety gate typically checks whether the scanner is blocked before allowing the forklift to enter the trailer. When the scanner is not available, the virtual safety gate provides additional safety checks before allowing the forklift to continue.

The virtual safety gate performs a handful of techniques to protect the human operator in the monitored area. The virtual safety gate consistently monitors the monitored area using the sensor on the dock subsystem. Based on sensor inputs, the sends a safety status signal to the forklift subsystem. The safety status signal is positive if the human worker is not in the monitored area.

The vehicle subsystem latches the state of the safety status signal until the forklift reaches the monitored area. The virtual safety gate knows the forklift is at the dock plate in front of the trailer when the plate detector senses the dock plate. At this point, the virtual safety gate then assesses the conditions as a whole. For example, the virtual safety gate considers the state of the safety status signal and the availability of the scanner. If the conditions are safe, then the virtual safety gate allows the forklift to enter. Further, the virtual safety gate checks that components, such as the plate detector, are operating correctly.

As the virtual safety gate operates, the vehicle subsystem observes the movement of the forklift. When the forklift passes the dock coupler, the vehicle subsystem receives the safety status signal through the vehicle coupler. The vehicle subsystem latches the state of the signal. The forklift then continues toward the monitored area. When the forklift is positioned over the dock plate, the vehicle subsystem detects the dock plate using the plate detector. The vehicle subsystem further checks whether the scanner is obstructed. If the scanner is blocked by the forks, the vehicle module only allows the forklift to continue if the safety status signal is positive. Otherwise, the vehicle subsystem commands the forklift to stop for the safety of the human worker.

The dock subsystem monitors the monitored area using the sensor. The controller in the dock subsystem receives a sensor signal from the sensor. The dock subsystem determines whether the human is in the monitored area based on the sensor signal. The dock subsystem transmits a safety status signal that communicates this information to the vehicle module. The dock coupler transmits the signal to the vehicle coupler when the forklift passes the dock coupler. The forklift continues toward the monitored area during this time. If the virtual safety gate stops the forklift, the dock subsystem activates the indicator to alert the human operator. The dock subsystem then waits to receive an input from the input device to ensure that the monitored area is clear and the human operator is not in danger. When the reset input is received, the virtual safety gate resumes operation of the forklift.

The virtual safety gate further checks that the plate detector is operating correctly. When the forklift is at the entrance to the trailer, one or more of the scanners detect the walls of the trailer. In other words, at least one of the scanners is able to detect whether or not the forklift or other vehicle is in the trailer. The virtual safety gate checks if the dock plate is detected by the plate detector. The virtual safety gate tracks both actions with a counter. Each time a wall of the trailer is detected, the counter increases by one. When the dock plate is detected, the counter decreases by one. If the counter is equal to the one, the virtual safety gate determines that the dock plate detector is working properly. Otherwise, if the counter did not decrease, the virtual safety gate determines that the dock plate detector is broken. The virtual safety follows Category 3 architecture standards by monitoring the components in this way.

With the virtual safety gate, the same scanner or a collection of multiple scanners can be used to perform safety monitoring. As one example of a practical scenario, the forklift truck has only two scanners. Both of the scanners are located at the floor level of the forklift, and the scanners are located on opposing diagonal corners of the forklift. In this scenario, the scanner on the fork-forward corner of the forklift gets blocked by the load, and the scanner on the rear corner of the forklift is not blocked by the load. Using the scanner data of both scanners together, the system under this scenario is still able to detect whether or not the forklift is inside a trailer.

The systems and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a monitored area.

Aspect 3 generally concerns the system of any previous aspect in which the monitored area includes a confined space.

Aspect 4 generally concerns the system of any previous aspect in which the monitored area includes a trailer.

Aspect 5 generally concerns the system of any previous aspect in which the confined space includes the trailer.

Aspect 6 generally concerns the system of any previous aspect in which the monitored area includes a warehouse aisle.

Aspect 7 generally concerns the system of any previous aspect in which the confined space includes the warehouse aisle located between storage racks.

Aspect 8 generally concerns the system of any previous aspect in which the monitored area includes a loading dock.

Aspect 9 generally concerns the system of any previous aspect in which the monitored area has an entrance.

Aspect 10 generally concerns the system of any previous aspect in which the loading dock has a doorway.

Aspect 11 generally concerns the system of any previous aspect in which the loading dock has a door opening.

Aspect 12 generally concerns the system of any previous aspect in which the entrance has an entryway zone.

Aspect 13 generally concerns the system of any previous aspect in which the entryway zone includes an entryway floor.

Aspect 14 generally concerns the system of any previous aspect in which the entryway zone is positioned at the entrance.

Aspect 15 generally concerns the system of any previous aspect in which the loading dock has a dock plate at the doorway.

Aspect 16 generally concerns the system of any previous aspect in which the loading dock has a dock leveler with the dock plate.

Aspect 17 generally concerns the system of any previous aspect in which the entryway zone has the dock plate.

Aspect 18 generally concerns the system of any previous aspect in which the dock plate is located at the entryway floor.

Aspect 19 generally concerns the system of any previous aspect in which the dock plate is made of metal.

Aspect 20 generally concerns the system of any previous aspect in which the dock plate is metallic.

Aspect 21 generally concerns the system of any previous aspect in which the metal is steel.

Aspect 22 generally concerns the system of any previous aspect in which the dock plate is composed of ferromagnetic material.

Aspect 23 generally concerns the system of any previous aspect in which the facility floor.

Aspect 24 generally concerns the system of any previous aspect in which the facility floor is located inside a warehouse.

Aspect 25 generally concerns the system of any previous aspect in which the facility floor defines a dock pit.

Aspect 26 generally concerns the system of any previous aspect in which the dock lever is disposed in the dock pit.

Aspect 27 generally concerns the system of any previous aspect in which the loading dock has a door positioned at the doorway to open and close the doorway.

Aspect 28 generally concerns the system of any previous aspect including an entrance sensor.

Aspect 29 generally concerns the system of any previous aspect in which the entrance sensor is configured to sense movement of an object through the entrance.

Aspect 30 generally concerns the system of any previous aspect in which the object includes a human.

Aspect 31 generally concerns the system of any previous aspect in which the object includes an animal.

Aspect 32 generally concerns the system of any previous aspect in which the entrance sensor is configured to sense movement into the monitored area.

Aspect 33 generally concerns the system of any previous aspect in which the entrance sensor is configured to detect movement through an entrance.

Aspect 34 generally concerns the system of any previous aspect in which the entrance sensor is positioned at the entrance.

Aspect 35 generally concerns the system of any previous aspect in which the entrance sensor is disposed on opposing sides of the entrance.

Aspect 36 generally concerns the system of any previous aspect in which the entrance sensor includes a light curtain.

Aspect 37 generally concerns the system of any previous aspect in which the entrance sensor includes an acoustic sensor.

Aspect 38 generally concerns the system of any previous aspect in which the entrance sensor includes a microwave sensor.

Aspect 39 generally concerns the system of any previous aspect in which the entrance sensor is positioned at a doorway of a loading dock.

Aspect 40 generally concerns the system of any previous aspect including a safety controller.

Aspect 41 generally concerns the system of any previous aspect in which the safety controller is operatively coupled to the entrance sensor.

Aspect 42 generally concerns the system of any previous aspect in which the safety controller is operatively coupled to the light curtain.

Aspect 43 generally concerns the system of any previous aspect in which the indicator operatively coupled to the safety controller.

Aspect 44 generally concerns the system of any previous aspect in which the indicator is configured to provide an alert.

Aspect 45 generally concerns the system of any previous aspect in which the indicator includes a light configured to provide a visual alert.

Aspect 46 generally concerns the system of any previous aspect in which the indicator includes a speaker configured to provide an audible alert.

Aspect 47 generally concerns the system of any previous aspect including a manual control operatively coupled to the safety controller.

Aspect 48 generally concerns the system of any previous aspect in which the manual control is configured to reset the safety controller.

Aspect 49 generally concerns the system of any previous aspect in which the manual control includes a reset button.

Aspect 50 generally concerns the system of any previous aspect including an entrance status coupler.

Aspect 51 generally concerns the system of any previous aspect in which the entrance status coupler is mounted proximal the entrance.

Aspect 52 generally concerns the system of any previous aspect in which the entrance status coupler is mounted above the floor.

Aspect 53 generally concerns the system of any previous aspect in which the entrance status coupler is mounted to a ceiling of a facility.

Aspect 54 generally concerns the system of any previous aspect in which the entrance status coupler is operatively coupled to the safety controller.

Aspect 55 generally concerns the system of any previous aspect in which the entrance status coupler is associated with a single entrance.

Aspect 56 generally concerns the system of any previous aspect in which the entrance status coupler includes a loading dock coupler.

Aspect 57 generally concerns the system of any previous aspect in which the loading dock coupler is located before the doorway of the loading dock.

Aspect 58 generally concerns the system of any previous aspect in which the dock plate is positioned between the loading dock coupler and the doorway of the loading dock.

Aspect 59 generally concerns the system of any previous aspect in which the entrance status coupler is mounted to be matched to a single loading dock.

Aspect 60 generally concerns the system of any previous aspect in which the dock subsystem includes the safety controller, the entrance sensor, the indicator, the manual control, and the entrance status coupler.

Aspect 61 generally concerns the system of any previous aspect including a vehicle.

Aspect 62 generally concerns the system of any previous aspect in which the vehicle is configured to travel into the monitored area.

Aspect 63 generally concerns the system of any previous aspect in which the vehicle is configured to travel through the entrance.

Aspect 64 generally concerns the system of any previous aspect in which the vehicle includes an autonomous mobile unit (AMU).

Aspect 65 generally concerns the system of any previous aspect in which the vehicle includes an autonomous vehicle.

Aspect 66 generally concerns the system of any previous aspect in which the vehicle includes an automated guided vehicle (AGV).

Aspect 67 generally concerns the system of any previous aspect in which the vehicle is autonomously controlled.

Aspect 68 generally concerns the system of any previous aspect in which the vehicle is semi-autonomously controlled.

Aspect 69 generally concerns the system of any previous aspect in which the vehicle is manually controlled.

Aspect 70 generally concerns the system of any previous aspect in which the vehicle is configured to move one or more items through the entrance.

Aspect 71 generally concerns the system of any previous aspect in which the vehicle is configured to carry the items.

Aspect 72 generally concerns the system of any previous aspect in which the vehicle has a safety scanner.

Aspect 73 generally concerns the system of any previous aspect in which the safety scanner is positioned on a forward-facing side of the vehicle.

Aspect 74 generally concerns the system of any previous aspect in which the safety scanner is a lidar sensor.

Aspect 75 generally concerns the system of any previous aspect in which the items block the safety scanner when carried by the vehicle.

Aspect 76 generally concerns the system of any previous aspect in which the vehicle positions the items at loading position to fit through the entrance.

Aspect 77 generally concerns the system of any previous aspect in which the items at the loading position block the view of the safety scanner.

Aspect 78 generally concerns the system of any previous aspect in which the vehicle is a forklift.

Aspect 79 generally concerns the system of any previous aspect in which the vehicle is an autonomous forklift.

Aspect 80 generally concerns the system of any previous aspect in which the forklift has one or more forks configured to carry the items.

Aspect 81 generally concerns the system of any previous aspect in which the items on the forks form a payload.

Aspect 82 generally concerns the system of any previous aspect in which the safety scanner is positioned at the forks.

Aspect 83 generally concerns the system of any previous aspect in which the payload obstructs the safety scanner when the forks are at a loading position.

Aspect 84 generally concerns the system of any previous aspect in which the forks have a lift height that is less than 400 mm from the floor at the loading position.

Aspect 85 generally concerns the system of any previous aspect including a virtual safety gate system.

Aspect 86 generally concerns the system of any previous aspect including a vehicle controller.

Aspect 87 generally concerns the system of any previous aspect in which the vehicle includes the vehicle controller.

Aspect 88 generally concerns the system of any previous aspect in which the vehicle controller is configured to control a vehicle.

Aspect 89 generally concerns the system of any previous aspect in which the vehicle controller is mounted to the vehicle.

Aspect 90 generally concerns the system of any previous aspect in which the vehicle controller includes a processor.

Aspect 91 generally concerns the system of any previous aspect in which the vehicle controller includes a computer.

Aspect 92 generally concerns the system of any previous aspect including a vehicle coupler.

Aspect 93 generally concerns the system of any previous aspect in which the vehicle coupler is mounted to the vehicle.

Aspect 94 generally concerns the system of any previous aspect in which the vehicle coupler is mounted at a position on the vehicle to communicate with the entrance status coupler.

Aspect 95 generally concerns the system of any previous aspect in which the vehicle coupler is operatively coupled to the vehicle controller.

Aspect 96 generally concerns the system of any previous aspect in which the entrance status coupler is configured to communicate with the vehicle coupler.

Aspect 97 generally concerns the system of any previous aspect in which the vehicle coupler includes a magnet.

Aspect 98 generally concerns the system of any previous aspect in which the vehicle coupler is an optical coupler.

Aspect 99 generally concerns the system of any previous aspect in which the entrance status coupler is an optical coupler.

Aspect 100 generally concerns the system of any previous aspect in which the entrance status coupler includes a transmitter.

Aspect 101 generally concerns the system of any previous aspect in which the entrance status coupler includes a transceiver.

Aspect 102 generally concerns the system of any previous aspect in which the vehicle coupler includes a receiver.

Aspect 103 generally concerns the system of any previous aspect in which the vehicle coupler includes a transceiver.

Aspect 104 generally concerns the system of any previous aspect in which the vehicle coupler includes a forklift coupler.

Aspect 105 generally concerns the system of any previous aspect in which the loading dock coupler is configured to establish unicast communication with the forklift coupler.

Aspect 106 generally concerns the system of any previous aspect in which the loading dock coupler is configured to communicate with the forklift coupler when the forklift coupler is positioned to face the loading dock coupler.

Aspect 107 generally concerns the system of any previous aspect in which the loading dock coupler is an 8-bit optic coupler.

Aspect 108 generally concerns the system of any previous aspect in which the forklift coupler is an 8-bit optic coupler.

Aspect 109 generally concerns the system of any previous aspect including a network device.

Aspect 110 generally concerns the system of any previous aspect in which the network device includes a wireless transceiver.

Aspect 111 generally concerns the system of any previous aspect in which the network device is operatively coupled to the vehicle controller.

Aspect 112 generally concerns the system of any previous aspect including an entryway zone detector.

Aspect 113 generally concerns the system of any previous aspect in which the entryway zone detector is operatively coupled to the vehicle controller.

Aspect 114 generally concerns the system of any previous aspect in which the entryway zone detector is configured to detect an entryway zone at the entrance.

Aspect 115 generally concerns the system of any previous aspect in which the entryway zone detector includes a plate detector.

Aspect 116 generally concerns the system of any previous aspect in which the plate detector is operatively coupled to the vehicle controller.

Aspect 117 generally concerns the system of any previous aspect in which the plate detector is a proximity detector.

Aspect 118 generally concerns the system of any previous aspect in which the plate detector is a magnetic sensor.

Aspect 119 generally concerns the system of any previous aspect in which the plate detector is mounted to the bottom of the forklift.

Aspect 120 generally concerns the system of any previous aspect in which the plate detector is configured to sense the dock plate.

Aspect 121 generally concerns the system of any previous aspect in which the vehicle controller includes a camera configured to detect a code on the floor of the loading dock.

Aspect 122 generally concerns the system of any previous aspect including a head scanner.

Aspect 123 generally concerns the system of any previous aspect in which the head scanner is operatively coupled to the vehicle controller.

Aspect 124 generally concerns the system of any previous aspect in which the head scanner is mounted to the forklift.

Aspect 125 generally concerns the system of any previous aspect in which the head scanner is configured to detect inner sidewalls of the trailer.

Aspect 126 generally concerns the system of any previous aspect in which the safety controller is configured to transmit one or more safety signals indicative safe entry into the monitored area.

Aspect 127 generally concerns the system of any previous aspect in which the safety controller is configured to transmit the safety signals when the entrance sensor fails to detect presence.

Aspect 128 generally concerns the system of any previous aspect in which the safety controller is configured to transmit the safety signals via the entrance status coupler.

Aspect 129 generally concerns the system of any previous aspect in which the safety controller is configured to transmit the safety signals via the dock coupler.

Aspect 130 generally concerns the system of any previous aspect in which the entrance status coupler is positioned along a travel path of the vehicle towards the entrance to unicast communicate with the vehicle coupler a status of the entrance senor.

Aspect 131 generally concerns the system of any previous aspect in which the entrance status coupler is configured to communicate a safe to enter status to the vehicle coupler when the entrance sensor does not detect anything.

Aspect 132 generally concerns the system of any previous aspect in which the entrance status coupler is configured to not communicate a safe to enter status to the vehicle coupler when the entrance sensor detects something.

Aspect 133 generally concerns the system of any previous aspect in which the vehicle controller is configured to stop the vehicle from moving towards the entrance when the safe to enter status is not received from the entrance coupler.

Aspect 134 generally concerns the system of any previous aspect in which the vehicle controller is configured to latch to the safe to enter status until the vehicle moves away from the entrance.

Aspect 135 generally concerns the system of any previous aspect in which the vehicle controller is configured to stop the vehicle from moving towards the entrance when the status of the entrance senor indicates something was sensed by the entrance sensor.

Aspect 136 generally concerns the system of any previous aspect in which the vehicle controller is configured to resume moving the vehicle towards the entrance when the manual control resets the status of the entrance sensor.

Aspect 137 generally concerns the system of any previous aspect in which the entryway zone detector is configured to monitor for at least one characteristic of the entryway zone at the entrance.

Aspect 138 generally concerns the system of any previous aspect in which the vehicle controller is configured to monitor for the entryway zone with the entryway zone detector when the vehicle is in the loading position.

Aspect 139 generally concerns the system of any previous aspect in which the vehicle controller is configured to stop the vehicle when the entryway zone is detected with the entryway zone detector and the safe to enter status is absent.

Aspect 140 generally concerns the system of any previous aspect in which the vehicle controller is configured to allow the vehicle travel through the entrance when the characteristic of the entryway zone is detected with the entryway zone detector and the safe to enter status is present.

Aspect 141 generally concerns the system of any previous aspect in which the vehicle is configured to travel into the monitored area when the characteristic of the entryway zone is detected with the entryway zone detector and the safe to enter status is provided by the entrance status coupler.

Aspect 142 generally concerns the system of any previous aspect in which the entrance status coupler is mounted overhead of the forklift before the dock plate of the loading dock.

Aspect 143 generally concerns the system of any previous aspect in which the loading dock coupler is configured to line of sight communicate with the forklift coupler when the forklift is positioned below the entrance status coupler.

Aspect 144 generally concerns the system of any previous aspect in which the vehicle controller of the forklift is configured to latch to a safe to enter status upon receiving a safe to enter status signal from the loading dock coupler.

Aspect 145 generally concerns the system of any previous aspect in which the vehicle controller of the forklift is configured to retain the safe to enter status upon moving forwards from the loading dock coupler to the dock plate.

Aspect 146 generally concerns the system of any previous aspect in which the vehicle controller of the forklift is configured to delete the safe to enter status upon moving backwards.

Aspect 147 generally concerns the system of any previous aspect in which the entrance sensor is configured to reset to the safe to enter status upon the reset button being actuated.

Aspect 148 generally concerns the system of any previous aspect in which the plate detector is configured to monitor for the dock plate when the forks are below a lift height limit.

Aspect 149 generally concerns the system of any previous aspect in which the lift height limit is 400 mm.

Aspect 150 generally concerns the system of any previous aspect in which the vehicle controller is configured to stop of the forklift when the plate detector detects the dock plate and the safe to enter status is missing.

Aspect 151 generally concerns the system of any previous aspect in which the vehicle controller is configured to permit the forklift to enter the doorway of the loading dock when the plate detector detects the dock plate and the safe to enter status is present.

Aspect 152 generally concerns the system of any previous aspect in which the forklift is configured to enter the trailer when the plate detector detects the dock plate and the safe to enter status is present.

Aspect 153 generally concerns the system of any previous aspect in which the loading dock coupler is operatively coupled to the safety controller.

Aspect 154 generally concerns the system of any previous aspect in which the forklift coupler is operatively coupled to the vehicle controller.

Aspect 155 generally concerns the system of any previous aspect in which the vehicle controller is configured to control a forklift.

Aspect 156 generally concerns the system of any previous aspect in which the plate detector is configured to monitor for the dock plate when the forks at or are below the loading position.

Aspect 157 generally concerns the system of any previous aspect in which the reset button is operatively coupled to the safety controller.

Aspect 158 generally concerns the system of any previous aspect in which the safety scanner is located on the forklift where the payload obstructs the safety scanner when the forks are at a loading position.

Aspect 159 generally concerns the system of any previous aspect in which the vehicle has a first scanner located on the vehicle where the items at the loading position block the view of the first scanner.

Aspect 160 generally concerns the system of any previous aspect including a second scanner operatively coupled to the vehicle controller.

Aspect 161 generally concerns the system of any previous aspect in which the second scanner is configured to detect one or more inner sidewalls of the trailer.

Aspect 162 generally concerns the system of any previous aspect in which the first scanner and the second scanner are positioned at a floor level of the vehicle.

Aspect 163 generally concerns the system of any previous aspect in which the first scanner and the second scanner are positioned at opposing corners of the vehicle.

Aspect 164 generally concerns a method.

Aspect 165 generally concerns the method of any previous aspect including monitoring an entrance for entry with an entrance sensor.

Aspect 166 generally concerns the method of any previous aspect including transmitting a safe to enter status from an entrance status coupler when the entrance sensor does not detect entry.

Aspect 167 generally concerns the method of any previous aspect including receiving the safe to enter status with a vehicle coupler mounted to a vehicle.

Aspect 168 generally concerns the method of any previous aspect including moving the vehicle towards the entrance.

Aspect 169 generally concerns the method of any previous aspect including detecting an entryway zone of the entrance with an entryway zone detector mounted on the vehicle.

Aspect 170 generally concerns the method of any previous aspect including advancing the vehicle through the entrance upon the receiving the safe to enter status and the detecting the entryway zone.

Aspect 171 generally concerns the method of any previous aspect including ceasing transmission of the safe to enter status when the entrance sensor detects entry.

Aspect 172 generally concerns the method of any previous aspect including stopping the vehicle upon detection of the ceasing transmission of the safe to enter status with the vehicle coupler and the detecting the entryway zone.

Aspect 173 generally concerns the method of any previous aspect including manually resetting the entrance sensor to resume transmission of the safe to enter status from the entrance status coupler.

Aspect 174 generally concerns the method of any previous aspect including initiating the detecting the entryway zone when the safety scanner is obstructed.

Aspect 175 generally concerns the method of any previous aspect including detecting the entryway zone includes detecting the dock plate with the plate detector.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a system including a virtual safety gate.

FIG. 2 is a diagram of the FIG. 1 system.

FIG. 3 is a block diagram of a dock subsystem installed at a loading dock from the FIG. 1 system.

FIG. 4 is a block diagram of a vehicle subsystem installed on a forklift from the FIG. 1 system.

FIG. 5 is a diagram of the FIG. 4 forklift and fields used by a head scanner on the forklift.

FIG. 6 is a diagram of the FIG. 1 system with the forklift moving in a forward direction.

FIG. 7 is a diagram of the FIG. 1 system with the forklift moving in a reverse direction.

FIG. 8 is a flowchart of a technique for operating the FIG. 1 virtual safety gate.

FIG. 9 is a flowchart of a technique for operating the FIG. 4 vehicle subsystem as a part of the FIG. 1 virtual safety gate.

FIG. 10 is a flowchart of another technique for operating the FIG. 4 vehicle subsystem as a part of the FIG. 1 virtual safety gate.

FIG. 11 is a flowchart of a technique for operating the FIG. 3 dock subsystem as a part of the FIG. 1 virtual safety gate.

FIG. 12 is a flowchart of yet another technique for operating the FIG. 4 vehicle subsystem as a part of the FIG. 1 virtual safety gate.

FIG. 13 is a flowchart of a technique for validating the function of an entryway zone detector on the FIG. 4 vehicle subsystem.

FIG. 14 is a flowchart of another technique for operating the FIG. 1 virtual safety gate.

FIG. 15 is a diagram of a logic architecture used by the FIG. 1 virtual safety gate according to one example.

FIG. 16 is a diagram of the FIG. 15 logic architecture in another state.

FIG. 17 is a diagram of the FIG. 15 logic architecture in yet another state.

FIG. 18 is a diagram of the FIG. 15 logic architecture in another state.

FIG. 19 is a diagram of the FIG. 15 logic architecture in yet another state.

FIG. 20 is a diagram of the FIG. 15 logic architecture in another state.

FIG. 21 is a diagram of the FIG. 15 logic architecture in yet another state.

FIG. 22 is a diagram of a logic architecture used by the FIG. 1 virtual safety gate according to another example.

FIG. 23 is a diagram of the FIG. 22 logic architecture in another state.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

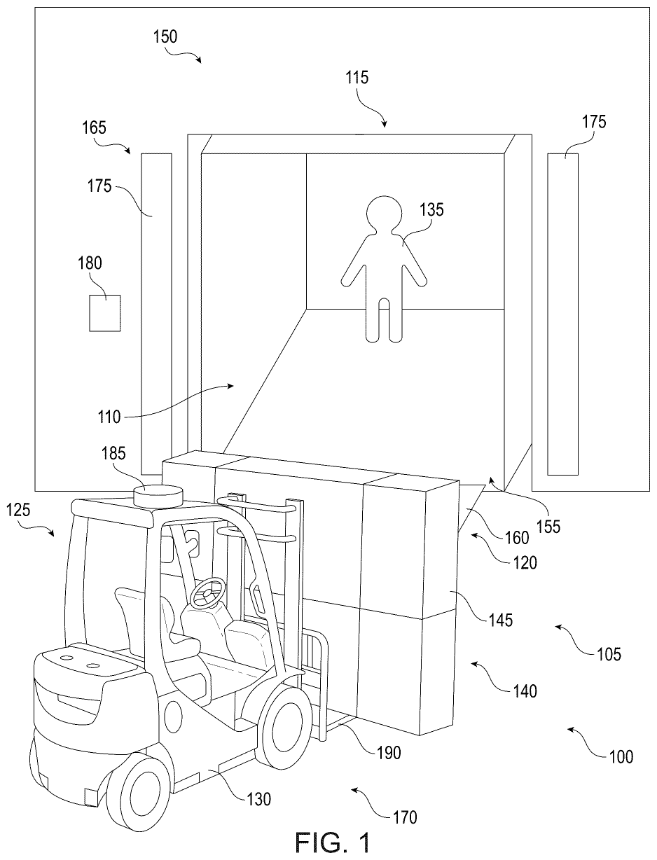

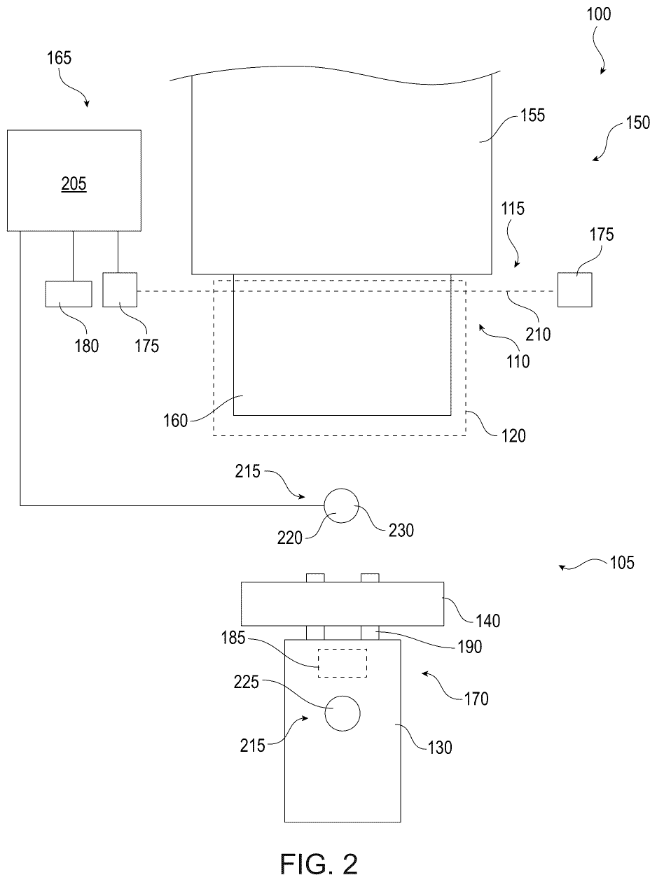

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 illustrates a safety gate system 100 that is configured to prevent accidents in shipping centers, manufacturing plants, warehouses, and/or other similar facilities as some examples. The system 100 protects human workers from incidental injuries caused by vehicles, robots, and/or other machines or equipment in the facility. Further, the system 100 prevents collisions and/or damage to other vehicles, other robots, equipment, animals, and/or other types of objects. The system 100 includes a virtual safety gate 105 that stops vehicles, including autonomous, semi-autonomous, and/or human-operated vehicles, when there is a risk of harm to humans, other vehicles, and/or other objects in the area. As an example, the virtual safety gate 105 prevents vehicles from moving beyond a certain point if a human worker is in the area. As should be acknowledged, the virtual safety gate 105 is configured to protect humans, other vehicles, equipment, and/or other objects from one or more vehicles, robots, and/or other machines in the facility.

Generally, the virtual safety gate 105 is configured to observe a monitored area 110 in the facility. The monitored area 110 typically includes an area where there is high risk for collisions and/or injuries, such as a confined space and the nearby area. The virtual safety gate 105 is configured to determine if humans and/or other objects are in the monitored area 110. When there is a risk of a vehicle and/or another machine coming into contact with the human, then the virtual safety gate 105 is configured to interrupt the vehicle to prevent the dangerous interaction. Monitoring the area and interrupting the vehicles in this way ensures that human workers in the facility stay safe. Further, the virtual safety gate 105 is configured to install onto existing equipment at the facility. The virtual safety gate 105 therefore provides reliable safety measures without requiring extensive hardware installations and/or replacing the existing equipment.

As illustrated, the monitored area 110 includes an entrance 115. The entrance 115 typically leads into a confined space. In some examples, the entrance 115 is a dock door, a gap between two storage racks, and/or another kind of doorway. The virtual safety gate 105 further monitors an entryway zone 120. The entryway zone 120 is a space in front of the entrance 115. In other words, a person or machine first enters the entryway zone 120 before crossing the entrance 115 and entering the monitored area 110. The system 100 further includes a vehicle 125 and a human operator 135. In the illustrated example, the vehicle 125 is in the form of a forklift 130. For the purposes of explanation, the system 100 is described using the forklift 130. As should be appreciated, the system 100 is configured to utilize the vehicle 125 in a variety of forms, such as a robotic shuttle and/or a robotic mast vehicle. In one example, the forklift 130 is autonomous or semi-autonomous, such as in the form of an autonomous mobile unit (AMU) and/or an automated guided vehicle (AGV). For instance, the forklift 130 utilizes artificial intelligence (AI) to perform one or more tasks. In another example, the forklift 130 is controlled by another human. The human operator 135 is a human person that performs various tasks in the facility. For example, the human operator 135 loads and/or unloads fragile or specialized items that the forklift 130 is not allowed to handle. As another example, the human operator 135 inspects shipments and/or performs other tasks. The virtual safety gate 105 is generally configured to stop the forklift 130 from moving forward if the human operator 135 is in the path of the forklift 130 near the monitored area 110. By stopping the forklift 130, the virtual safety gate 105 ensures that the human operator 135 is not crushed, trapped, and/or harmed in other ways by the forklift 130. The virtual safety gate 105 is primarily explained as protecting the human operator 135. As noted, the virtual safety gate 105 is also configured to prevent damage to other forklifts 130 and/or equipment. In one version, the virtual safety gate 105 commands the forklift 130 to stop operating until the human operator 135 provides manual feedback that the area is clear.

Typically, the forklift 130 handles a payload 140. For example, the forklift 130 lifts and transports the payload 140. The payload 140 includes one or more items 145. The items 145 generally include boxes, packages, products, raw materials, equipment, and/or shelving as some examples. In some cases, the payload 140 is large and creates an increased risk to the human operator 135. For instance, there is a higher risk for a larger payload 140 to strike the human operator 135 as the forklift 130 operates. In the illustrated example, the payload 140 extends across the majority of the front of the forklift 130. Large payloads 140 typically impede the ability of a driver and/or a monitoring device on the forklift 130 to effectively monitor the surroundings of the forklift 130.

In the illustrated example, the virtual safety gate 105 is implemented at a loading dock 150 in the facility. The loading dock 150 is generally an area of a facility used for loading outgoing shipments and/or unloading incoming shipments. For the purpose of explanation, the virtual safety gate 105 is generally described in the environment of the loading dock 150. As should be appreciated, the virtual safety gate 105 can be implemented in one or more alternative or additional areas of the facility, such as in a storage area, a packing area, and/or routing area.

As illustrated, the loading dock 150 generally provides a space for the trailer 155 to dock for loading and/or unloading. The trailer 155 is a rigid structure that provides a space to hold the items 145, such as for storage and/or shipping. For example, the trailer 155 is a wheeled trailer configured to be hauled by a tractor and/or truck. Typically, the forklift 130 drives into the trailer 155 to pick up or place the payload 140. In the illustrated example, the monitored area 110 includes the inside of the trailer 155. In some other examples, the monitored area 110 includes confined areas between various shelving structures, pieces of manufacturing equipment, conveyor belts, stacks of products, and/or pallets of materials in a facility or warehouse. The virtual safety gate 105 generally protects the human operator 135 from being harmed by the forklift 130 in the trailer 155. At most, many traditional safety arrangements rely on physical barriers in front of the trailer 155 to separate the human operator 135 and the forklift 130. In some instances, the human operator 135 needs to enter the trailer 155 to inspect the shipment and/or manually handle the payload 140. Such traditional measures are generally not effective at preventing the forklift 130 from entering the trailer 155. For instance, traditional measures fail if the human operator 135 has temporarily removed the barrier and entered the trailer 155. If the forklift 130 operates normally, there is a risk for the forklift 130 to enter the trailer 155 before the human operator 135 has left. Further, there is a risk for the payload 140 to block on-board safety measures on the forklift 130. In such a confined space, there is a high risk for the human operator 135 to be seriously injured and almost no opportunity for the human operator 135 to avoid the forklift 130. The virtual safety gate 105 protects the human operator 135 in such scenarios by monitoring the environment and stopping the forklift 130 if the human operator 135 is in the trailer 155. Unlike traditional systems, the virtual safety gate 105 allows the human operator 135 to enter the trailer 155 while blocking the forklift 130 from entering the trailer 155. In this way, the virtual safety gate 105 ensures that the human operator 135 is not injured by the forklift 130 when working near the trailer 155. As should be appreciated, the virtual safety gate 105 is configured to protect the human operator 135 in a similar way in a variety of different monitored areas 110.

As shown, the loading dock 150 typically includes a dock plate 160. The dock plate 160 generally bridges any gap between the trailer 155 and the floor of the loading dock 150. Typically, the dock plate 160 is made of rigid metal, such as aluminum or steel. Further, the dock plate 160 is typically made of a ferromagnetic material. In one example, the dock plate 160 is part of a dock leveler in a dock pit at the loading dock 150. The dock plate 160 is located in the entryway zone 120. The virtual safety gate 105 is generally configured to detect when the forklift 130 is in the entryway zone 120. In one version, the virtual safety gate 105 is configured to check for the dock plate 160 before entering the trailer 155, such as through a proximity sensor and/or metal detector. Checking for the dock plate 160 provides an additional layer of safety for the virtual safety gate 105 and provides more information about the position and surrounding environment of the forklift 130.

The virtual safety gate 105 is typically incorporated across multiple parts of the system 100. Specifically, the virtual safety gate 105 is installed partially on the loading dock 150 and partially on the forklift 130. The virtual safety gate 105 includes a dock subsystem 165 installed on the loading dock 150 and a vehicle subsystem 170 installed on the forklift 130. Further, the system 100 generally includes multiple loading docks 150 and multiple forklifts 130. When one of the forklifts 130 approaches one of the loading docks 150, a complete virtual safety gate 105 is formed between the dock subsystem 165 and the vehicle subsystem 170 from that loading dock 150 and forklift 130 pair. The dock subsystems 165 are universally interfaceable with the vehicle subsystems 170 such that any dock subsystem 165 is configured to pair with any vehicle subsystem 170. Using universally interfaceable components allows the virtual safety gate 105 to function in a standardized and uniform way at any combination of different loading docks 150 and forklifts 130. For instance, the same components are used on multiple different dock subsystems 165 such that a given forklift 130 is configured to interface with any loading dock 150. Similarly, the same components are used at multiple different vehicle subsystems 170 such that a given loading dock 150 is configured to interface with any forklift 130. The dock subsystem 165 from any loading dock 150 and the vehicle subsystem 170 from any forklift 130 are configured to cooperate to form the complete virtual safety gate 105. Therefore, the virtual safety gate 105 is operable when any forklift 130 is present at one of the loading docks 150. Using universally interfaceable dock subsystems 165 and vehicle subsystems 170 allows the virtual safety gate 105 to be installed on existing loading docks 150 and forklifts 130 in a consistent way. Further, installing the same vehicle subsystems 170 on different vehicles 125 ensures that the virtual safety gate 105 functions consistently regardless of the type of vehicle 125 being used at the loading dock 150.

As illustrated, the dock subsystem 165 of the virtual safety gate 105 includes a sensor 175 and a manual control 180. The sensor 175 is configured to detect objects in the area, such as objects passing into or out of the monitored area 110. In one version, the sensor 175 monitors the entrance 115 of the monitored area 110 using one or more beams of light (i.e., electromagnetic radiation), sound waves, and/or other forms of radiation. For example, the sensor 175 includes one or more ultrasonic sensors, acoustic sensors, light beam sensors, laser sensors, photoelectric sensors, and/or other devices. In one particular example, the sensor 175 is in the form of a light beam sensor that utilizes infrared, ultraviolet, visible light, microwaves, and/or other types of light. The light beam sensor utilizes light arranged as a beam, laser, polarized light, and/or in other arrangements. In such an example, the virtual safety gate 105 includes one sensor 175 positioned on either side of the entrance 115 at the trailer 155 to form a light curtain. In other examples, the sensor 175 includes one or more radio frequency identification (RFID) sensors, pressure sensors, safety scanners, cameras, vision systems, proximity sensors, thermal sensors, capacitive sensors, and/or electromagnetic sensors to name a few examples. Using the sensor 175, the virtual safety gate 105 is able to determine when the human operator 135, the forklift 130, and/or other objects are in the monitored area 110.

The manual control 180 allows the human operator 135 to manually notify the virtual safety gate 105 that the trailer 155 is safe for the forklift 130 to enter. The manual control 180 allows the virtual safety gate 105 to receive manual inputs in a variety of ways, such as through a physical input, gesture, voice command, badge swipe, and/or code scan to name a few examples. As some examples, the manual control 180 includes one or more physical buttons, switches, foot pedals, touchscreens, microphones, scanners, badge readers, cameras, and/or other devices. For the purpose of explanation, the manual control 180 is primarily described as a push button. As should be acknowledged, the virtual safety gate 105 utilizes the manual control 180 as a push button and/or in one or more other forms. In one example, if the virtual safety gate 105 has determined that the human operator 135 is at risk and stops the vehicle forklift 130, the virtual safety gate 105 will not allow the forklift 130 to resume operating until the human operator 135 has pressed the manual control 180. The manual control 180 is typically located near the monitored area 110, such as to the side of the trailer 155, to ensure that the human operator 135 actually checks the monitored area 110 before allowing the forklift 130 to restart. In another example, the manual control 180 is located on the human operator 135, such as in the form of a handheld device.

The vehicle subsystem 170 of the virtual safety gate 105 includes a head scanner 185. The head scanner 185 monitors the surroundings of the forklift 130. Typically, the head scanner 185 is used to detect the human operator 135 and/or specific parts of the loading dock 150. For example, the head scanner 185 monitors the monitored area 110 for the human operator 135 when the forklift 130 has entered the monitored area 110. As another example, the head scanner 185 detects parts of the trailer 155 and/or other features in the monitored area 110 to provide information about the position of the forklift 130 to the virtual safety gate 105. The head scanner 185 includes a laser scanner, a camera, and/or another type of sensor to observe the area surrounding the forklift 130. In the illustrated example, the head scanner 185 is positioned on a top side of the forklift 130. In other examples, the head scanner 185 is positioned on a front side of the forklift 130 and/or on a bottom side of the forklift 130. In yet another example, the vehicle subsystem 170 includes multiple head scanners 185 that each monitor a different area around the forklift 130. Oftentimes, the head scanner 185 is a sufficient safety measure to protect the human operator 135 from the forklift 130. However, in some cases, the view of the head scanner 185 is obscured or completely blocked by part of the forklift 130 and/or the payload 140. The head scanner 185 is therefore not reliable in such conditions. The virtual safety gate 105 provides additional safety measures to ensure that the human operator 135 remains safe when the head scanner 185 is obstructed.

The virtual safety gate 105 is configured to operate with a high degree of safety. In one version, the virtual safety gate 105 has a performance level (PL) d safety rating or higher. Performance level is a safety rating for machinery controls that ranges from PLa to PLe, with PLe having the most robust safety measures. To operate within the PLd rating, the probability of a dangerous failure occurring per hour must be between 0.00001% and 0.000001%. At a higher PL rating, this probability is even lower, meaning the virtual safety gate 105 operates more safely. In some cases, the PL rating is determined at least partially based on characteristics of the injuries that the virtual safety gate 105 protects against. For example, the PL rating is based on the severity of injuries, frequency and/or exposure rate of injuries, and the probability of avoiding injuries. The virtual safety gate 105 is generally configured to protect against serious injuries, such as irreversible injuries and/or death. In some examples, the virtual safety gate 105 protects against infrequent risks and/or risks with short exposure time that are nearly impossible to avoid. For instance, such risks include the human operator 135 being trapped by forklift 130 in the trailer 155 with a low probability for the human operator 135 to escape. In other examples, the virtual safety gate 105 protects against frequent risks and/or risks with long exposure time that the human operator 135 can occasionally avoid. For instance, such risks include the human operator 135 consistently working near the forklift 130 and the trailer 155 with some possibility for the human operator 135 to avoid the forklift 130.

The virtual safety gate 105 further utilizes Category 3 safety architecture. Category 3 architecture involves redundant circuitry and/or components to ensure that the virtual safety gate 105 still operates correctly if a component fails. This greatly reduces the chance that the virtual safety gate 105 would fail completely at any given time. Further, Category 3 architecture involves cross-monitoring redundant channels and/or outputs on devices to determine whether those devices are operating properly. For example, the virtual safety gate 105 monitors and compares multiple redundant outputs from the sensor 175, the head scanner 185, and/or other devices. As another example, the virtual safety gate 105 utilizes outputs from the head scanner 185 to validate the function of one or more other devices. This allows the virtual safety gate 105 to monitor for part failures to allow any faulty components to be repaired and/or replaced.

The virtual safety gate 105 continuously monitors the loading dock 150 to determine if the human operator 135 has entered the monitored area 110. When the forklift 130 approaches the monitored area 110, the virtual safety gate 105 evaluates whether conditions are safe for vehicle forklift 130 to enter the monitored area 110. In one version, if the head scanner 185 has a clear view of the monitored area 110, then the virtual safety gate 105 allows the forklift 130 to enter the monitored area 110 and to rely on the head scanner 185 to avoid the human operator 135. If the virtual safety gate 105 determines that the human operator 135 is not in the monitored area 110, then the forklift 130 is generally allowed to proceed into the monitored area 110. In one example, if the sensor 175 has not sensed the human operator 135 enter, then the virtual safety gate 105 determines the monitored area 110 is clear. In another example, the virtual safety gate 105 uses the sensor 175 to check that no other forklifts 130 have entered the monitored area 110. Conversely, if the virtual safety gate 105 determines that the human operator 135 has entered the monitored area 110, the virtual safety gate 105 halts operation of the forklift 130. Further, the virtual safety gate 105 and indicates this to the human operators 135 in the loading dock 150 using lights, displayed messages, alarm noises, and/or other forms of feedback. Afterwards, the virtual safety gate 105 waits for the human operator 135 to press the manual control 180 to allow the forklift 130 to resume operation. The virtual safety gate 105 utilizes additional layers of safety features to ensure that no accidents happen at the loading dock 150. For example, the virtual safety gate 105 utilizes additional scanners and/or sensors on the forklift 130 that check for human operators 135 nearby. Further, as noted, the virtual safety gate 105 checks for the dock plate 160 beneath the forklift 130 before allowing the forklift 130 to enter the trailer 155. Typically, the virtual safety gate 105 includes redundant complimentary inputs from the various sensors and other components. For instance, the virtual safety gate 105 utilizes redundant complimentary inputs from the sensor 175. The complimentary inputs ensure that the virtual safety gate 105 receives accurate information about the status of the system 100 in case certain components fail on one input. This allows the virtual safety gate 105 to meet the requirements of Category 3 safety architecture and to reliably protect the human operators 135 in the facility.

As shown, the forklift 130 includes forks 190. The forks 190 are configured to carry the payload 140. In one example, the forks 190 are specially adapted to carry certain types of items 145. In other examples, the forks 190 are generally configured to carry a wide variety of types of items 145. The forks 190 are moved to a loading position based on the payload 140 being carried. For instance, the forks 190 are lowered when the forklift 130 carries a tall payload 140 to allow the payload 140 to fit through the entrance 115 and beneath the ceiling of the trailer 155. As another example, the forks 190 are raised to carry the payload 140 at particular support points on the payload 140. In some cases, the forks 190 and/or the payload 140 block the head scanner 185 on the forklift 130. For instance, in the FIG. 1 illustration, the payload 140 extends above the forklift 130 and across nearly the entire front side of the forklift 130. As a result, the head scanner 185 does not have a clear view to monitor the monitored area 110 and to check for the human operator 135. The virtual safety gate 105 is configured to determine when the head scanner 185 is blocked by the forks 190 and/or the payload 140. The virtual safety gate 105 then provides additional safety measures to compensate for the impaired head scanner 185. As noted, the system 100 is configured to utilize a variety of types of the vehicle 125 which utilize various tools in place of or in addition to the forks 190. For explanation purposes, the virtual safety gate 105 is described in the context of using the forks 190 to handle the payload 140. It should be appreciated that the virtual safety gate 105 is configured to work with vehicles 125 that utilize different tools to handle the payload 140.

Referring to FIG. 2, the dock subsystem 165 further includes a controller 205. The controller 205 generally communicates with the other components in the dock subsystem 165, such as the sensor 175 and the manual control 180. In one version, the vehicle subsystem 170 stores and performs all the safety logic of the virtual safety gate 105, and the controller 205 is configured to communicate information from the sensor 175 and/or manual control 180 to the vehicle subsystem 170. In an alternate version, the controller 205 performs at least part of the safety logic for the virtual safety gate 105. The controller 205 is generally configured to communicate with any vehicle subsystem 170. Therefore, the controller 205 at any loading dock 150 supports forming an operational virtual safety gate 105 with any forklift 130.

As shown, the sensor 175 monitors a sensor barrier 210. The sensor barrier 210 generally extends along the entrance 115, such as at the opening to the trailer 155. By sensing when the sensor barrier 210 is crossed, the sensor 175 determines that the human operator 135, the forklift 130, or another object has entered the monitored area 110. In an example using light beam sensors, the sensor 175 produce a light curtain that forms the sensor barrier 210. The light curtain is generally formed from many lasers and/or other beams of light emitted by one or more sensors 175. The sensor 175 senses when the beams of light from the sensor barrier 210 are broken. The sensor barrier 210 extends horizontally across the opening to the trailer 155. For instance, in the illustrated example, the sensor barrier 210 extends between two sensors 175 that are spaced across the opening to the trailer 155. As should be appreciated, the sensor 175 is positioned differently depending on the type of sensor 175 that is used. Further, the sensor barrier 210 generally extends across the height of the trailer 155. This allows the sensor 175 to monitor a 2-dimensional cross-section over most or all of the opening to the trailer 155. Therefore, the sensor 175 is configured to reliably detect any instances of the human operator 135 entering the trailer 155.

The virtual safety gate 105 further includes multiple data transmission devices 215. The data transmission devices 215 are generally configured to transmit and/or receive information. In one version, the data transmission devices 215 communicate wirelessly, such as through Bluetooth, acoustic waves, radio waves, and/or other electromagnetic waves as some examples. In another version, the data transmission devices 215 communicate through electrical conductors, such as through one or more conductive rails, terminals, and/or other electrical contacts. As shown, both the dock subsystem 165 and the vehicle subsystem 170 include one data transmission device 215, and the data transmission devices 215 are installed on both the loading dock 150 and the forklift 130. The dock subsystem 165 includes an entrance status coupler 220 and the vehicle subsystem 170 includes a vehicle coupler 225. The entrance status coupler 220 is typically mounted overhead, such as on rafters, on a vertical support, and/or another structure. In the illustrated example, the entrance status coupler 220 is in the form of a dock coupler 230. The dock coupler 230 is adapted to be used in the loading dock 150. In one example, the dock coupler 230 is mounted in front and/or above a dock door at the loading dock 150. The vehicle coupler 225 is typically mounted on a top side of the forklift 130. The entrance status coupler 220 is typically positioned along a path that the forklift 130 travels on the way to the monitored area 110. In one example, the entrance status coupler 220 is positioned to be directly above the vehicle coupler 225 when the forklift 130 passes. Further, in one example, the entrance status coupler 220 and the vehicle coupler 225 utilize line of sight communication. In an example using optical couplers, the entrance status coupler 220 sends light (i.e., electromagnetic radiation) pulses via line of sight propagation. For instance, the entrance status coupler 220 is oriented to face directly toward the vehicle coupler 225 when the forklift 130 drives under the entrance status coupler 220. As should be appreciated, the data transmission devices 215 are configured to communicate with one another using a variety of physical arrangements of the entrance status coupler 220 and the vehicle coupler 225.

Typically, the entrance status coupler 220 at each loading dock 150 is agnostic of the particular vehicle coupler 225 and the particular forklift 130. This allows the entrance status coupler 220 to communicate with the vehicle coupler 225 on each forklift 130 in the same way. Communicating in this way enables the virtual safety gate 105 to operate using any pairing of dock subsystem 165 and vehicle subsystem 170. Typically, the entrance status coupler 220 is configured to transmit a safe to enter signal to the vehicle coupler 225. The safe to enter signal generally indicates the status of the monitored area 110. For instance, the entrance status coupler 220 sends a positive signal to the vehicle coupler 225 as long as the sensor barrier 210 has not been crossed. Further, the entrance status coupler 220 is configured to unicast the signal to the vehicle coupler 225. In other words, the entrance status coupler 220 communicates directly with the vehicle coupler 225 rather than broadcasting a signal to all nearby devices. The data transmission devices 215 are generally configured to communicate when the forklift 130 is positioned below the entrance status coupler 220. By communicating in this way, the virtual safety gate 105 knows the relative position of the forklift 130 within the loading dock 150 at the time the safe to enter signal is sent. The entrance status coupler 220 is typically positioned close to the entrance 115 to ensure that the forklift 130 receives the present status of the monitored area 110 before entering. In one example, the entrance status coupler 220 automatically transmits the safe to enter signal to the vehicle coupler 225 when the forklift 130 drives under the entrance status coupler 220. In another example, the entrance status coupler 220 first detects the presence of the vehicle coupler 225 and the forklift 130, such as by receiving a signal from the vehicle coupler 225 and/or using a separate detector device as some examples.

The entrance status coupler 220 and the vehicle coupler 225 are configured to communicate with one another in a variety of ways. In one example, the entrance status coupler 220 is configured only to transmit data to the vehicle coupler 225, and the vehicle coupler 225 is configured only to receive such data. For instance, the entrance status coupler 220 simply sends the safety status of the virtual safety gate 105 to the vehicle coupler 225. In another example, both the entrance status coupler 220 and the vehicle coupler 225 are configured to send and receive data. For instance, the vehicle coupler 225 receives and sends information about the status of the virtual safety gate 105 to the entrance status coupler 220. In one version, the data transmission devices 215 are in the form of optic couplers. In one particular example, the data transmission devices 215 are 8-bit optic couplers that are configured to send and/or receive multiple signals simultaneously. Using multiple signal paths allows the data transmission devices 215 to send redundant safe to enter signals, such as complimentary signals, to act as a failsafe. Again, these redundant safe to enter signals ensure that the virtual safety gate 105 follows Category 3 architecture. The multiple signal paths further allow the data transmission devices 215 to communicate additional information beyond the safe to enter signal, such as a muting signal for the sensor 175. Further, the multiple signal paths allow the entrance status coupler 220 and the vehicle coupler 225 to simultaneously send and receive data, such as different status updates about the virtual safety gate 105. In one version, all communication between the dock subsystem 165 and the vehicle subsystem 170 are performed by the data transmission devices 215. In another version, the dock subsystem 165 and the vehicle subsystem 170 further communicate via a network, such as a local area network (LAN), a mobile network, and/or the Internet as examples.

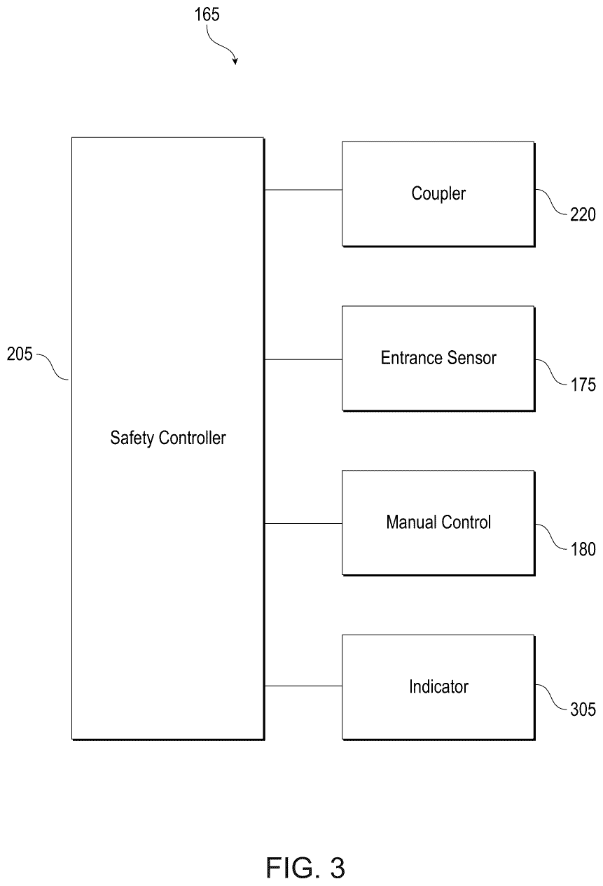

FIG. 3 depicts a block diagram of the dock subsystem 165 of the virtual safety gate 105 according to one example. As shown, the dock subsystem 165 includes the controller 205, the entrance status coupler 220, the sensor 175, the manual control 180, and an indicator 305. The controller 205 is communicatively connected to the entrance status coupler 220, the sensor 175, the manual control 180, and the indicator 305 through wired and/or wireless connections. The controller 205 connects to some components using multiple connections so as to receive multiple inputs. For example, as noted, the controller 205 is configured to receive two complimentary inputs from the sensor 175 as a failsafe. Further, the controller 205 is configured to send two complimentary outputs through the entrance status coupler 220. In one example, the controller 205 is further configured to receive one or more inputs from the entrance status coupler 220, such as a muting signal for the sensor 175.

The indicator 305 is configured to alert the human operator 135 if the conditions at the loading dock 150 are unsafe. For example, the controller 205 activates the indicator 305 if the human operator 135 has entered the trailer 155 and the forklift 130 has been stopped. The indicator 305 generally includes a light. The indicator 305 is configured to illuminate in a solid color, such as red, and/or to flash when alerting the human operator 135. In one example, the indicator 305 illuminates in one color, such as green, when the monitored area 110 is safe for the forklift 130 to enter, and switches colors and/or flashes when the monitored area 110 becomes unsafe. In another example, the indicator 305 further includes a speaker and is configured to provide an auditory alert to the human operator 135. The indicator 305 is configured to receive commands from the controller 205. In one example, the indicator 305 is configured to receive two inputs from the controller 205, such as complimentary redundant inputs and/or different control inputs. As should be appreciated, the dock subsystem 165 supports using any number of indicators 305 in a variety of arrangements within the loading dock 150.

The dock subsystem 165 is generally installed in the loading dock 150. In the FIGS. 1 and 2 example, the dock subsystem 165 is installed as multiple separate components at the loading dock 150. In an alternate example, the dock subsystem 165 is contained in a large common housing. The entrance status coupler 220 and the indicator 305 are typically mounted in the loading dock 150, such as above the path of the forklift 130 and/or above the door to the trailer 155. In one example, the sensors 175 are mounted on either lateral side of the entrance 115. In other examples, the sensors 175 are mounted away from the monitored area 110, positioned on the facility floor near the entrance 115, and/or positioned in other ways. The manual control 180 is positioned adjacent the monitored area 110. In one example, the manual control 180 and the indicator 305 are mounted in a shared housing. One or more indicators 305 are alternatively or additionally mounted at other points around the loading dock 150. In another example, the indicator 305 is a handheld or other wireless device given to the human operator 135.

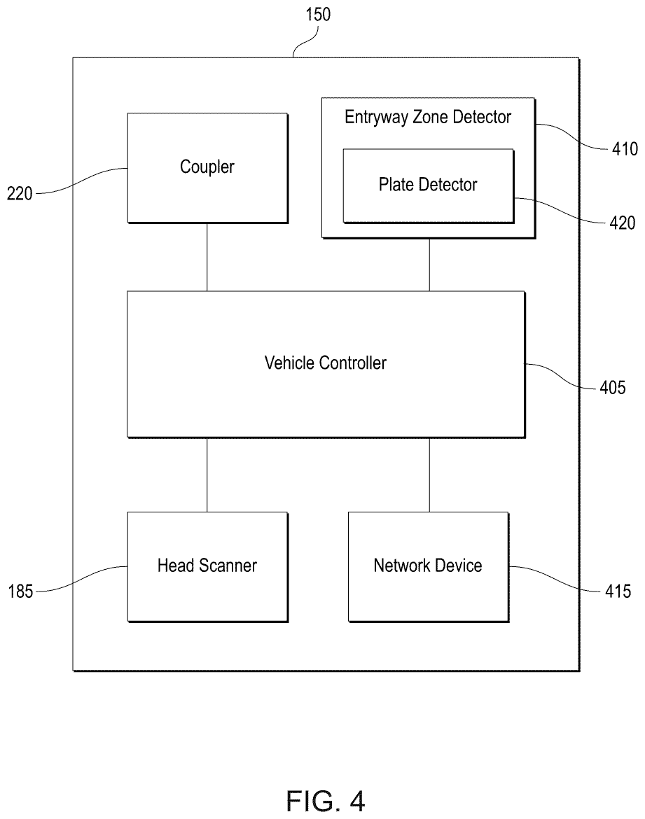

FIG. 4 depicts a block diagram of the vehicle subsystem 170 of the virtual safety gate 105 according to one example. As shown, the vehicle subsystem 170 generally includes a vehicle controller 405, an entryway zone detector 410, a network interface 415, the head scanner 185, and the vehicle coupler 225. In one version, the vehicle subsystem 170 is contained in a housing on the forklift 130. Such a contained housing facilitates installing the vehicle subsystem 170 on the forklift 130. In another version, the components of the vehicle subsystem 170 are positioned at various points on the forklift 130. For example, the entryway zone detector 410 is positioned on a bottom side of the forklift 130, and the head scanner 185 is positioned on a top side, a bottom side, and/or a front side of the forklift 130. In yet another example, one or more components of the vehicle subsystem 170 are already part of the forklift 130. For instance, the vehicle subsystem 170 utilizes a head scanner 185 that has been previously installed on the forklift 130.

The vehicle controller 405 is communicatively connected to and configured to control the other components of the vehicle subsystem 170. The vehicle controller 405 executes and/or stores logic, controls, software, algorithms, and/or other information. In one example, the vehicle controller 405 is wired to the entryway zone detector 410, the network interface 415, the head scanner 185, and the vehicle coupler 225 through multiple conductors. The vehicle controller 405 is further configured to communicate with the forklift 130 and/or directly control the forklift 130. In one example, the vehicle controller 405 includes a guidance, navigation, and control (GNC) system that controls movement of the forklift 130. In another example, the vehicle controller 405 is configured to communicate with a GNC system that is either on the forklift 130 or controlling the forklift 130 remotely. Additionally, in one version, the vehicle controller 405 is configured to control the entire virtual safety gate 105. For instance, the vehicle controller 405 stores and/or executes all of the safety logic of the virtual safety gate 105. In that version, the vehicle controller 405 is configured to communicate with the controller 205 on the dock subsystem 165 through the data transmission devices 215 and/or over a network. Using centralized control on the vehicle controller 405 allows the virtual safety gate 105 to operate reliably when the dock subsystem 165 pairs with different vehicle subsystems 170. For example, using the centralized control on the vehicle controller 405 can avoid miscommunication between the dock subsystem 165 and the vehicle subsystem 170 and/or other issues.

The entryway zone detector 410 is configured to sense the entryway zone 120 when the forklift 130 is positioned in or near the entryway zone 120. The entryway zone detector 410 includes one or more sensors to detect the entryway zone 120. In the example at the loading dock 150, the entryway zone detector 410 includes a plate detector 420. The plate detector 420 is configured to sense the dock plate 160 when the forklift 130 is above the dock plate 160. The plate detector 420 includes a proximity sensor, a metal detector, and/or another type of sensor to detect the dock plate 160. The sensors of the entryway zone detector 410 and the plate detector 420 generally include an inductive sensor, a magnetometer, a laser sensor, a light sensor, an ultrasonic sensor, and/or a camera among other examples. For the purpose of explanation, the entryway zone detector 410 is generally described in the form of the plate detector 420. It should be appreciated that the virtual safety gate 105 is configured to utilize the entryway zone detector 410 in a variety of forms beyond just the plate detector 420. In one example, the entryway zone detector 410 is further calibrated to account for ambient lighting in the loading dock 150. For instance, the entryway zone detector 410 is configured to ignore a certain amount of light noise that is expected at the loading dock 150. In another example, the entryway zone detector 410 is configured to raise and lower from the forklift 130. For instance, the entryway zone detector 410 is normally in a raised position to provide sufficient clearance from the facility floor during normal operation. When the entryway zone detector 410 approaches the entrance 115, such as when passing the entrance status coupler 220, the vehicle subsystem 170 lowers the entryway zone detector 410. In some cases, identifying features of the entryway zone 120 are positioned on the facility floor. Lowering the entryway zone detector 410 closer to the facility floor ensures that the output from the entryway zone detector 410 is reliable. In one example, the entryway zone detector 410 identifies the entryway zone 120 by scanning a quick response (QR) code and/or reading another marker on the floor. In another example, the plate detector 420 detects the dock plate 160 due to the ferromagnetic properties of the dock plate 160. As should be appreciated, the vehicle subsystem 170 is configured to move the entryway zone detector 410 in other ways to detect different features of the entryway zone 120. To avoid false positives and/or other failures, the entryway zone detector 410 is connected to the vehicle controller 405 to output complimentary redundant signals. For instance, the entryway zone detector 410 is configured to send one normally high output and one normally low output that each change states when the entryway zone 120 is detected.

The network interface 415 is configured to connect the vehicle controller 405 to a network, such as a LAN and/or another type of network. In one version, the network interface 415 is configured to receive a wired ethernet connection. In another version, the network interface 415 is configured to connect the vehicle controller 405 to a network wirelessly. Using the network interface 415, the vehicle controller 405 is able to communicate with other systems and/or devices in the facility, such as a facility-wide control system, the vehicle controllers 405 on other forklifts 130, and/or the controllers 205 at the loading docks 150 as examples.

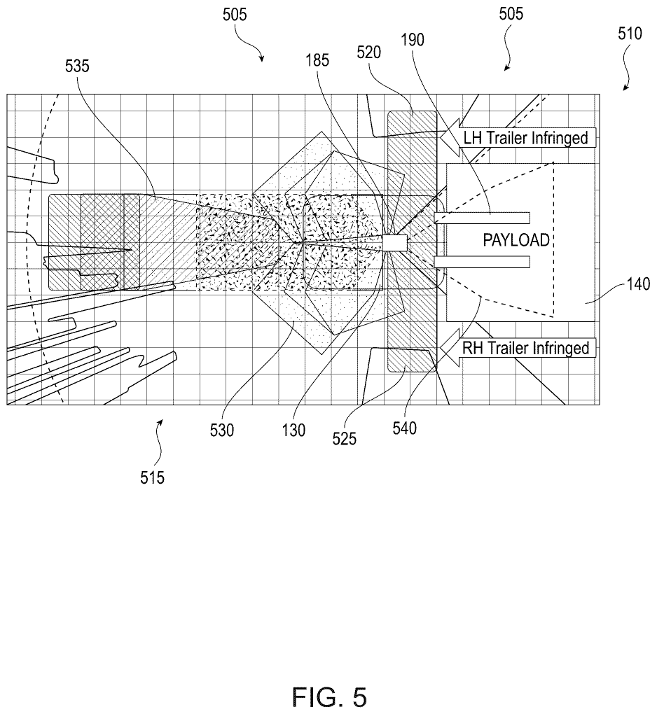

Referring to FIG. 5, the head scanner 185 is configured to monitor multiple fields 505 around the forklift 130. The fields 505 generally extend toward both a front end 510 and a rear end 515 of the forklift 130. The shapes of the fields 505 are generally customizable. In one example, software on the vehicle controller 405 and/or the head scanner 185 defines the fields 505 that the head scanner 185 observes. In another example, the physical arrangement of lasers and/or other sensors in the head scanner 185 define the fields 505 being observed. Customizing the shapes of the fields 505 allows the head scanner 185 to target and/or avoid various features of the trailer 155 and/or the loading dock 150. In one example, the forklift 130 includes one head scanner 185 for each field 505. In another example, one or more head scanners 185 monitor multiple fields 505. The head scanner 185 is typically mounted near a bottom side or a top side of the forklift 130. Mounting the head scanner 185 in those locations typically provides an unobstructed view for the head scanner 185 to cover the desired fields 505. In an alternate example, multiple head scanners 185 are positioned along a perimeter of the forklift 130. For instance, at least one head scanner 185 is positioned near the front end 510 of the forklift 130 to provide an unobstructed view of the fields 505 on the front end 510, and/or at least one head scanner 185 is positioned near the rear end 515 of the forklift 130 to provide an unobstructed view of the fields 505 on the rear end 515.

In the illustrated example, the fields 505 include a left trailer field 520, a right trailer field 525, a central field 530, a rear field 535, and a front field 540. The left trailer field 520 and the right trailer field 525 extend over areas on the lateral sides of the forklift 130. Further, the left trailer field 520 and the right trailer field 525 extend partly toward the front end 510. The left trailer field 520 and the right trailer field 525 are generally arranged to detect the walls and/or doors on the trailer 155. For example, when the forklift 130 is entering the trailer 155, the left trailer field 520 is arranged to detect the left sidewall of the trailer 155, and the right trailer field 525 is arranged to detect the right sidewall of the trailer 155. Monitoring the left trailer field 520 and the right trailer field 525 allows the head scanner 185 to detect when the forklift 130 is entering the trailer 155. In one version, the vehicle controller 405 validates the function of one or more components in the vehicle subsystem 170 based on sensor data from the left trailer field 520 and/or the right trailer field 525. For example, the vehicle controller 405 uses such information to ensure the entryway zone detector 410 is working properly. Further, the head scanner 185 is configured to monitor the left trailer field 520 and the right trailer field 525 for the human operator 135 to ensure that the forklift 130 does not contact and injure the human operator 135.

The central field 530 and the rear field 535 provide additional coverage for the head scanner 185 around the forklift 130. The central field 530 primarily extends around an area surrounding the center and slightly toward the rear end 515 of the forklift 130. The central field 530 provides coverage in an area very close to the forklift 130. By monitoring the central field 530 for the human operator 135 and/or objects in the loading dock 150, the head scanner 185 ensures that the forklift 130 does not contact and injure the human operator 135 and/or damage the loading dock 150. The rear field 535 primarily extends toward the rear end 515 of the forklift 130 and provides coverage further behind the forklift 130. Monitoring the rear field 535 allows the head scanner 185 to detect the human operator 135 and/or objects in the loading dock 150 while the forklift 130 backs up, such as when exiting the trailer 155. In one version, the central field 530 and/or the rear field 535 include the combination or superposition of multiple fields 505. The virtual safety gate 105 is configured to stop the forklift 130 if the head scanner 185 detects the human operator 135 in the central field 530 and/or the rear field 535.

The front field 540 provides coverage for the head scanner 185 on the front end 510 of the forklift 130. Monitoring the front field 540 for the human operator 135 and/or obstructions allows the head scanner 185 to detect the human operator 135 and/or obstacles when the forklift 130 is driving forward, such as when entering the trailer 155. In one version, the virtual safety gate 105 allows the forklift 130 to enter the trailer 155 as long as the head scanner 185 is monitoring the front field 540. In this way, after the forklift 130 has entered the monitored area 110, the head scanner 185 is configured to signal the vehicle controller 405 to stop the vehicle only if the human operator 135 is detected. Because the forks 190 are positioned on the front end 510 of the forklift 130, the head scanner 185 is occasionally obstructed from monitoring the front field 540. In some cases, the head scanner 185 is obstructed when the forks 190 are in a loading position. For instance, when the forks 190 are below a certain height, the forks 190 and/or the payload 140 being carried blocks the view of the head scanner 185 toward the front end 510. In such cases, it is dangerous to allow the forklift 130 to enter the monitored area 110 without other precautions. The virtual safety gate 105 generally provides effective precautions when the view of the front field 540 is obstructed. By stopping the forklift 130 when the human operator 135 is in the monitored area 110, the virtual safety gate 105 ensures the safety of the human operator 135 in the monitored area 110 when the head scanner 185 cannot effectively monitor the monitored area 110.

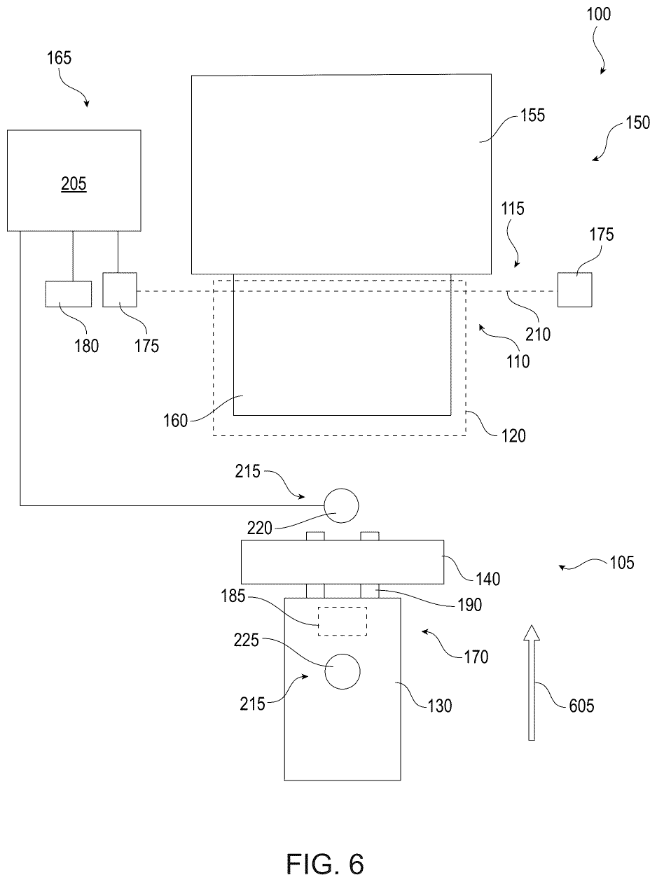

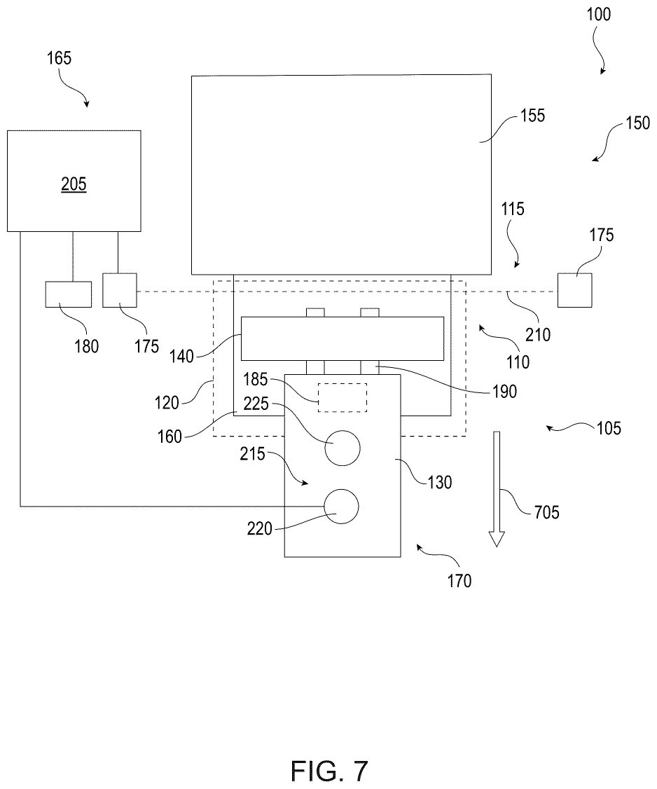

FIGS. 6 and 7 illustrate various positions and movement of the forklift 130 at the loading dock 150. In the FIG. 6 example, the forklift 130 is moving in the direction of a forward arrow 605 toward the monitored area 110. As the forklift 130 moves forward, the entrance status coupler 220 and the vehicle coupler 225 eventually align. At that point, the vehicle subsystem 170 receives information about the status of the monitored area 110 from the dock subsystem 165 via the data transmission devices 215. When the monitored area 110 is clear, the forklift 130 is allowed to continue forward into the monitored area 110.

In the FIG. 7 example, the forklift 130 is moving away from the monitored area 110 in the direction of a reverse arrow 705. In the illustrated example, the forklift 130 is positioned past the entrance status coupler 220. In one version, even if the vehicle subsystem 170 has received a positive safe to enter signal (i.e., the monitored area 110 is clear), the virtual safety gate 105 is configured to reset the safety status when the forklift 130 reverses. In other words, the virtual safety gate 105 considers the monitored area 110 unsafe when the forklift 130 reverses until the vehicle subsystem 170 receives a positive safe to enter signal again. In one scenario, the forklift 130 reverses temporarily before entering the monitored area 110. In another scenario, the forklift 130 reverses out of the monitored area 110 after loading and/or unloading. In either case, there is a chance for the human operator 135 to see the forklift 130 reverse and to determine individually that the monitored area 110 is safe to enter. The virtual safety gate 105 protects the human operator 135 from potential injury in such scenarios by preventing the forklift 130 from entering the monitored area 110 directly after reversing.

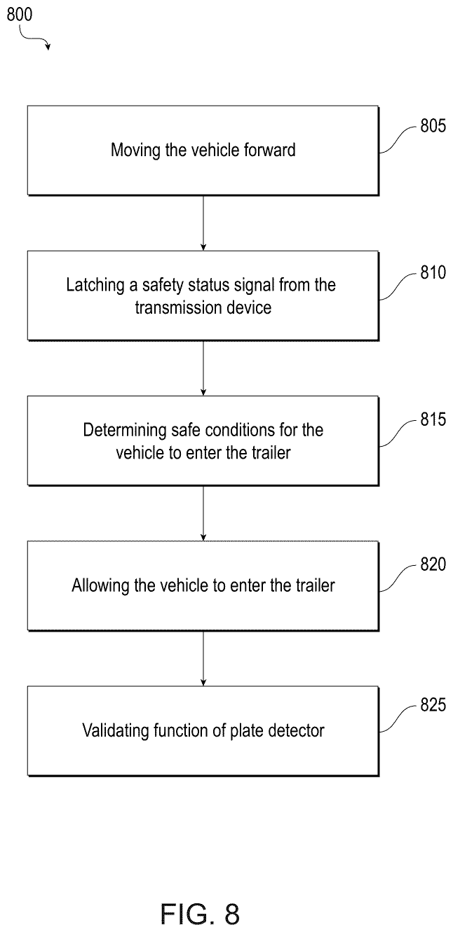

Referring to FIGS. 8, 9, 10, 11, 12, 13, and 14, the virtual safety gate 105 is configured to perform a technique for preventing dangerous interactions between the forklift 130 and the human operator 135. The technique generally includes monitoring the forklift 130, the human operator 135, and/or the monitored area 110. The technique generally allows the virtual safety gate 105 to perform at or above a PLd safety rating. Specifically, the technique allows the virtual safety gate 105 to prevent serious injuries and/or death caused by the forklift 130 crushing, trapping, and/or contacting the human operator 135 in the trailer 155 and/or other confined monitored areas 110. The technique is described for protecting the human operator 135 from the forklift 130. As should be appreciated, the technique is applicable to protecting other forklifts 130, vehicles 125, and/or equipment that are in the monitored area 110. Further, the technique is described in the setting of the loading dock 150 and the trailer 155. However, the technique is generally applicable to other settings and different forms of the monitored area 110. The virtual safety gate 105 is generally configured to perform the technique. As should be appreciated, one or more parts of the virtual safety gate 105 are configured to perform certain parts of the techniques described in the following figures. In one version, the vehicle controller 405 is configured to perform all the steps of the techniques.

FIG. 8 depicts a flowchart 800 of a technique for protecting the human operator 135 in the monitored area 110. As noted, the virtual safety gate 105 is generally configured to perform the technique of the flowchart 800. Various parts of the virtual safety gate 105, such as the dock subsystem 165, the vehicle subsystem 170, the controller 205, and/or the vehicle controller 405, are configured to perform one or more parts of the technique. At stage 805, the forklift 130 moves forward, such as in the general direction of the forward arrow 605 in FIG. 6. The forklift 130 typically starts in a position behind the entrance status coupler 220 relative to the entrance 115. In one example, the virtual safety gate 105 controls the movement of the forklift 130. For instance, the vehicle controller 405 controls the forklift 130 and commands the forklift 130 to drive forward at stage 805. In another example, virtual safety gate 105 observes the movement of the forklift 130. In that case, the movement of the forklift 130 is controlled by a human driver, a separate controller on the forklift 130, and/or another device. The virtual safety gate 105 generally observes the movement of the forklift 130. For instance, the entrance status coupler 220, the entryway zone detector 410, the head scanner 185, and/or another device provides information to the virtual safety gate 105 about the position of the forklift 130 at the loading dock 150.

At stage 810, the virtual safety gate 105 latches a safe to enter signal communicated by the data transmission devices 215. The virtual safety gate 105 typically latches the signal when the forklift 130 passes the entrance status coupler 220. The dock subsystem 165 transmits the signal to the vehicle subsystem 170 using the entrance status coupler 220. The vehicle subsystem 170 receives the signal using the vehicle coupler 225. In one version, the entrance status coupler 220 is constantly transmitting the signal and vehicle coupler 225 receives the signal once the forklift 130 is positioned under the entrance status coupler 220. In another version, the entrance status coupler 220 detects the presence of the forklift 130 and then transmits the signal to the vehicle coupler 225. As noted, the safe to enter signal is sent using two channels of the data transmission devices 215. The redundant signals ensure that the virtual safety gate 105 receives a reliable signal and/or detects a fault if any components have failed. The virtual safety gate 105 adheres to Category 3 safety architecture by using redundant signals and assessing faults in this way. The virtual safety gate 105 typically latches the safe to enter signal only if the signal is positive. In other words, the virtual safety gate 105 stores the state of the signal only when the signal indicates the monitored area 110 is clear. Otherwise, the virtual safety gate 105 does not latch the signal. Alternatively, the virtual safety gate 105 stores the state of the signal regardless of the state.

At stage 815, the virtual safety gate 105 determines whether the conditions are safe for the forklift 130 to enter the monitored area 110. During this time the forklift 130 typically continues to move toward the monitored area 110. The virtual safety gate 105 considers the safe to enter signal from stage 810. Additionally, the virtual safety gate 105 considers one or more other factors. In one example, the virtual safety gate 105 considers the availability of the head scanner 185 to detect the human operator 135 in the monitored area 110. For instance, the virtual safety gate 105 checks whether the head scanner 185 is obstructed by the forks 190 and/or the payload 140. In another example, the virtual safety gate 105 checks for the entryway zone 120 using the entryway zone detector 410. For instance, the virtual safety gate 105 uses the plate detector 420 to sense the dock plate 160. Checking for the entryway zone 120 ensures that the forklift 130 is positioned in front of the trailer 155. Further, checking for the dock plate 160 in particular ensures that the forklift 130 is able to drive into the trailer 155. In other settings, the virtual safety gate 105 is configured to check for other features before entering the monitored area 110. The virtual safety gate 105 determines it is safe for the forklift 130 to proceed if the head scanner 185 is unobstructed and/or if the safe to enter signal is latched positive when the entryway zone 120 is detected. After determining the monitored area 110 is clear for the forklift 130, the virtual safety gate 105 continues to stage 820. At stage 820, the virtual safety gate 105 allows the forklift 130 to continue forward. In one example, the virtual safety gate 105 mutes the output from the sensor 175 as the forklift 130 crosses the entrance 115. In the monitored area 110, the forklift 130 typically performs given tasks, such as placing and/or picking up the payload 140 from the trailer 155. The forklift 130 then exits the monitored area 110, such as by driving in reverse.

After allowing the forklift 130 to enter and performs tasks in the monitored area 110, the virtual safety gate 105 continues to stage 825. At stage 825, the virtual safety gate 105 validates the function of the entryway zone detector 410. In one version, the virtual safety gate 105 performs this step as the forklift 130 exits the trailer 155. In another version, the virtual safety gate 105 performs this step as the virtual safety gate 105 is entering. The virtual safety gate 105 utilizes other equipment to verify the position of the forklift 130 with respect to the trailer 155. For instance, the virtual safety gate 105 uses the head scanner 185 to detect the walls of the trailer 155, such as in the left trailer field 520 and/or the right trailer field 525 as shown in FIG. 5. The virtual safety gate 105 then determines if the entryway zone detector 410 appropriately detected the entryway zone 120 when the forklift 130 was in the correct position. Validating the function of parts such as the entryway zone detector 410 allows the virtual safety gate 105 to monitor for failures. As noted, monitoring for failures allows the virtual safety gate 105 meet the standards of Category 3 safety architecture.

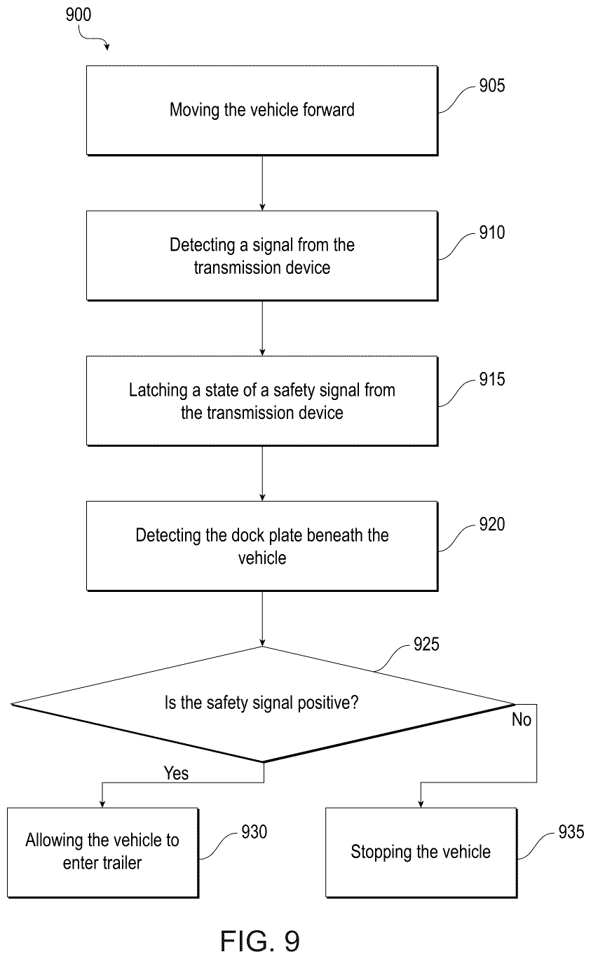

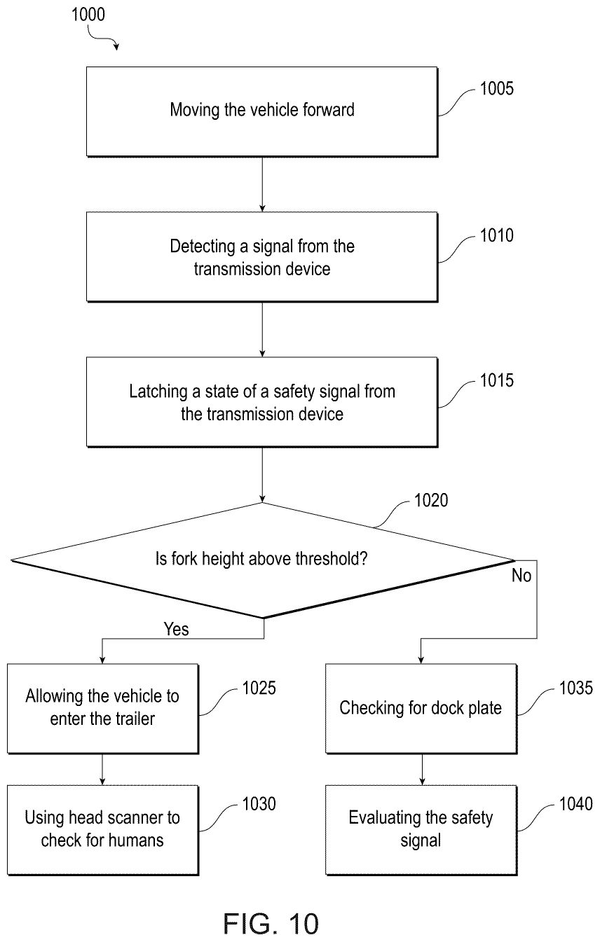

FIGS. 9 and 10 show techniques for operating the vehicle subsystem 170 of the virtual safety gate 105. The vehicle subsystem 170 generally performs these techniques as a part of the technique of FIG. 8. The techniques in FIGS. 9 and 10 are generally described as being performed by the vehicle subsystem 170. Various parts of the vehicle subsystem 170 and/or the virtual safety gate 105 are configured to perform one or more part of the techniques. For example, the vehicle controller 405 and/or other devices are configured to perform one or more parts of the techniques of FIGS. 9 and 10. Further, the virtual safety gate 105 and/or the vehicle subsystem 170 are configured to utilize a combination of various parts of the techniques in FIGS. 9 and 10.

Referring to FIG. 9, a flowchart 900 illustrates a technique for operating the vehicle subsystem 170 of the virtual safety gate 105. At stage 905, the forklift 130 moves forward in the same way as at stage 805 in FIG. 8. As noted, in one version, the vehicle controller 405 is configured to control the movement of the forklift 130. As the forklift 130 moves forward, the vehicle subsystem 170 performs stage 910. At stage 910, the vehicle subsystem 170 detects the safe to enter signal using the vehicle coupler 225. The vehicle coupler 225 operates in the same way as described at stage 810 in FIG. 8. In one example, the vehicle coupler 225 detects the entrance status coupler 220 and/or communicates with entrance status coupler 220 before receiving the safe to enter signal. In another example, the vehicle coupler 225 receives the signal from the entrance status coupler 220 as soon as the vehicle coupler 225 is positioned appropriately to receive the signal from the vehicle coupler 225. In the example where the entrance status coupler 220 and the vehicle coupler 225 are optic couplers, the vehicle coupler 225 receives the safe to enter signal when the vehicle coupler 225 is aligned with the entrance status coupler 220. When the entrance status coupler 220 and the vehicle coupler 225 are aligned, light (i.e., electromagnetic radiation) emitted from the entrance status coupler 220 is directed toward the vehicle coupler 225.

After receiving the safe to enter signal using the vehicle coupler 225, the vehicle subsystem 170 continues to stage 915. At stage 915, the vehicle subsystem 170 latches the state of the safe to enter signal. The vehicle subsystem 170 performs the latching step in the same way as described at stage 815 in FIG. 8. As noted, in one example, the vehicle subsystem 170 latches the safe to enter signal if the state of the signal is positive (i.e., the monitored area 110 is clear).

At stage 920, the vehicle subsystem 170 detects the entryway zone 120. For instance, the vehicle subsystem 170 senses the dock plate 160 under the forklift 130 using the plate detector 420. In one example, the plate detector 420 detects metal in the dock plate 160 using an inductive sensor, a magnetometer, and/or another device. Further, in one example, the vehicle subsystem 170 lowers the entryway zone detector 410 toward the facility floor before and/or during this step to ensure accurate sensing. Detecting the entryway zone 120 generally serves as a checkpoint for the virtual safety gate 105 regarding the position of the forklift 130. The virtual safety gate 105 typically waits to evaluate the safety status until the forklift 130 reaches the entryway zone 120. This allows the virtual safety gate 105 to assess the conditions immediately before the forklift 130 enters the trailer 155. As should be appreciated, the vehicle subsystem 170 is configured to detect other markers leading up to the monitored area 110 in different types of settings. Similarly, the entrance status coupler 220 is positioned near the monitored area 110 to provide the vehicle subsystem 170 with the current information about the monitored area 110 before the forklift 130 enters.

At stage 925, the vehicle subsystem 170 begins assessing the condition of the monitored area 110. Specifically, the vehicle subsystem 170 checks the state of the latched safe to enter signal. In one example, the vehicle subsystem 170 only latches the signal if the signal is positive. In that example, the vehicle subsystem 170 only checks whether the safe to enter signal is latched at stage 925. As noted, the vehicle subsystem 170 utilizes redundant inputs to ensure reliability and to check for faults in the virtual safety gate 105. The vehicle subsystem 170 further ensures that the redundant input signals match at stage 925. If the redundant signals do not match, the vehicle subsystem 170 determines that there is a fault and treats the status the same as if it were unlatched and/or negative (i.e., the monitored area 110 is not clear).

If the safe to enter signal is latched and positive, the vehicle subsystem 170 continues to stage 930. At stage 930, the vehicle subsystem 170 allows the forklift 130 to continue traveling into the monitored area 110 and to perform tasks. If the safe to enter signal is not latched and/or negative, the vehicle subsystem 170 continues to stage 935. At stage 935, the vehicle subsystem 170 commands the forklift 130 to stop via one or more safety command signals. The vehicle subsystem 170 commands the forklift 130 to halt until the virtual safety gate 105 is reset. Further, the vehicle subsystem 170 typically activates the indicator 305 to alert the human operator 135 and/or other individuals that the forklift 130 is stopped. The alert from the indicator 305 prompts the human operator 135 to return to a safe position away from the forklift 130 and/or to manually check the monitored area 110. The virtual safety gate 105 then waits for the human operator 135 to reset the virtual safety gate 105 using the manual control 180.

Referring to FIG. 10, a flowchart 1000 illustrates another technique for operating the vehicle subsystem 170 of the virtual safety gate 105. The technique in FIG. 10 incorporates one or more parts of the technique in FIG. 9. At stage 1005, the forklift 130 moves forward. The actions at stage 1005 are performed in the same way as at stage 905 in FIG. 9. At stage 1010, the vehicle subsystem 170 detects the safe to enter signal using the vehicle coupler 225 in the same way as at stage 910 in FIG. 9. Then at stage 1015, the vehicle subsystem 170 latches the state of the safe to enter signal in the same way as at stage 915 in FIG. 9.

The vehicle subsystem 170 then continues to stage 1020. At stage 1020, the vehicle subsystem 170 evaluates the position of the forks 190 on the forklift 130. Evaluating the position of the forks 190 allows the vehicle subsystem 170 to determine whether the head scanner 185 is obstructed. As should be appreciated, the vehicle subsystem 170 is configured to determine whether the head scanner 185 is obstructed in one or more additional or alternative ways. As noted, the forks 190 and/or the payload 140 block the head scanner 185 from detecting the human operator 135 in the front field 540 when the forks 190 are lowered below a certain point. At stage 1020, the vehicle subsystem 170 determines the height of the forks 190 from the facility floor and compares the height to a threshold height. In one example, the threshold height is 400 millimeters. The threshold height is determined based on the position and size of the head scanner 185 on the forklift 130.

If the height of the forks 190 is above the threshold height, the vehicle subsystem 170 continues to stage 1025. Because the forks 190 are determined to be above the head scanner 185, the vehicle subsystem 170 determines that the head scanner 185 is unobstructed. The virtual safety gate 105 therefore relies on the head scanner 185 to detect the human operator 135 within the monitored area 110. At stage 1025, the vehicle subsystem 170 allows the forklift 130 to continue moving forward into the monitored area 110. While the forklift 130 enters the monitored area 110, the vehicle subsystem 170 continues to stage 1030. At stage 1030, the vehicle subsystem 170 utilizes the head scanner 185 to scan the monitored area 110 and monitor for the human operator 135, other forklifts 130, and/or other equipment. For example, the vehicle subsystem 170 uses the head scanner 185 to monitor the front field 540, as shown in FIG. 5, to detect the presence of the human operator 135. If the head scanner 185 detects the human operator 135 while the forklift 130 is in the monitored area 110, the vehicle subsystem 170 commands the forklift 130 to stop, activates the indicator 305, and/or waits for a reset input. For instance, in that case, the vehicle subsystem 170 performs the same actions as at stage 935 in FIG. 9.

Conversely, if the height of the forks 190 is below the threshold height, the vehicle subsystem 170 continues to stage 1035. The forks 190 generally obstruct the view of the head scanner 185 in this case. The vehicle subsystem 170 therefore does not allow the forklift 130 to continue or to rely on the head scanner 185. Instead, the vehicle subsystem 170 utilizes the other safety features of the virtual safety gate 105 to ensure the human operator 135 is not harmed. At stage 1035, the vehicle subsystem 170 checks for the entryway zone 120 using the entryway zone detector 410. For instance, the vehicle subsystem 170 checks for the dock plate 160 using the plate detector 420. The vehicle subsystem 170 generally performs the same actions as at stage 920 in FIG. 9. The vehicle subsystem 170 then continues to stage 1040. At stage 1040, the vehicle subsystem 170 evaluates the safety status of the monitored area 110. The vehicle subsystem 170 generally performs the same actions as at stage 925, stage 930, and/or stage 935 in FIG. 9. For example, the vehicle subsystem 170 checks that the safe to enter signal is latched and positive. If the safe to enter signal is positive, the monitored area 110 is determined to be clear from the human operator 135. In that case, the forklift 130 is allowed to enter the monitored area 110. Otherwise, the vehicle subsystem 170 stops the forklift 130 in the same way as step stage 935 in FIG. 9.

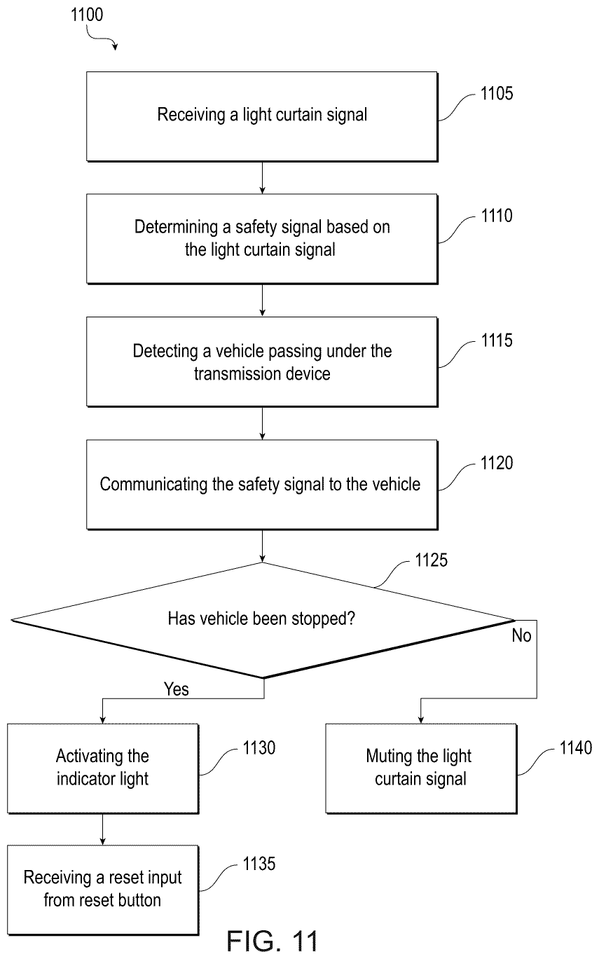

FIG. 11 depicts a flowchart 1100 for a technique for operating the dock subsystem 165 of the virtual safety gate 105. The dock subsystem 165 generally performs this technique as a part of the technique in FIG. 8. The technique of the flowchart 1100 is generally described as being performed by the controller 205 of the dock subsystem 165. As should be appreciated, various parts of the dock subsystem 165 and/or the virtual safety gate 105 are configured to perform one or more parts of the technique. For example, the controller 205 and/or the vehicle controller 405 are configured to perform one or more parts of the technique.

At stage 1105, the controller 205 receives a sensing signal from the sensor 175. As noted, the virtual safety gate 105 utilizes many redundant inputs to ensure reliability and to monitor the functionality of components in the virtual safety gate 105. The controller 205 receives multiple redundant inputs from the sensor 175. The sensing signal from the sensor 175 communicates to the controller 205 whether the entrance 115 has been crossed. Typically, the controller 205 is configured to mute signals from the sensor 175 when the forklift 130 is crossing the sensor barrier 210. In this way, the controller 205 avoids accidental false positives. In one example, the sensor 175 and/or the controller 205 are configured to determine explicitly whether the human operator 135 has crossed entered the monitored area 110, such as using a scanner, a vision system, and/or a camera as examples. The controller 205 then continues to stage 1110. Based on the signal from the sensor 175, the controller 205 determines a safe to enter signal. The safe to enter signal generally indicates whether it is safe for the forklift 130 to enter the monitored area 110. The safe to enter signal is positive if the human operator 135 is not in the monitored area 110. For example, the controller 205 sets the state of the safe to enter signal to positive if the sensor 175 has not detected the human operator 135 enter the trailer 155.

The controller 205 then continues to stage 1115 and stage 1120. At stage 1115, the controller 205 detects the forklift 130 passing under the entrance status coupler 220. In one version, the controller 205 continues to stage 1120 and does not necessarily detect the forklift 130. At stage 1120, the controller 205 communicates the safe to enter signal to the vehicle subsystem 170 using the entrance status coupler 220. The controller 205 performs one or more actions as described at stage 910 in FIG. 9. As noted, the controller 205 sends the safe to enter signal on multiple channels of the data transmission devices 215 so as to provide redundant inputs to the vehicle subsystem 170. In one example, the controller 205 continuously transmits the safe to enter signal until the forklift 130 is positioned under the entrance status coupler 220 and the vehicle coupler 225 receives the signal.

During this time, the controller 205 generally waits to receive communications from other parts of the virtual safety gate 105. For example, the controller 205 waits to receive information from the vehicle controller 405 via the data transmission devices 215 and/or a network. At stage 1125, the controller 205 checks whether the forklift 130 has been stopped. In one example, the vehicle controller 405 controls when the forklift 130 is stopped. In another example, the controller 205 sends a signal to the vehicle controller 405 to stop the forklift 130. If the forklift 130 has been stopped, such as at stage 935 in FIG. 9 and/or at stage 1040 in FIG. 10, the controller 205 continues to stage 1130. At stage 1130, the controller 205 activates the indicator 305 to alert the human operator 135, other individuals, and/or other parts of the system 100. Typically, the controller 205 controls the indicator 305 to illuminate in red and/or flash at stage 1130. Further, the indicator 305 produces noise, such as an alarm sound and/or a safety message as some examples. In one version, the indicator 305 is normally illuminated in green and/or another color to indicate the monitored area 110 is safe. Alternatively, the indicator 305 is powered off until the controller 205 activates the indicator 305 at stage 1130. The controller 205 then continues to stage 1135 to wait for a reset signal from the manual control 180. The indicator 305 generally prompts the human operator 135 and/or other workers to manually inspect the monitored area 110 and ensure that the forklift 130 can safely resume operations. When the human operator 135 has determined that operations can resume, the human operator 135 then presses the manual control 180 to reset the virtual safety gate 105. The controller 205 then receives the reset signal from the manual control 180 and restarts operations. For instance, the controller 205 then continues back to stage 1105.

Conversely, if the forklift 130 has not been stopped at stage 1125, the controller 205 continues to stage 1140. The forklift 130 is generally allowed to enter the monitored area 110 at this point. For example, the virtual safety gate 105 has performed the actions of stage 930 in FIG. 9 and/or stage 1025 in FIG. 10 at this point. Because the forklift 130 has to cross the sensor barrier 210 to enter the monitored area 110, the controller 205 mutes the sensing signals from the sensor 175 at stage 1140. This prevents the sensor 175 from falsely triggering the virtual safety gate 105 when conditions are safe. In one example, the controller 205 unmutes the sensing signal once the forklift 130 has passed the sensor barrier 210. In another example, the controller 205 waits until the forklift 130 exits the monitored area 110 to unmute the sensing signal.

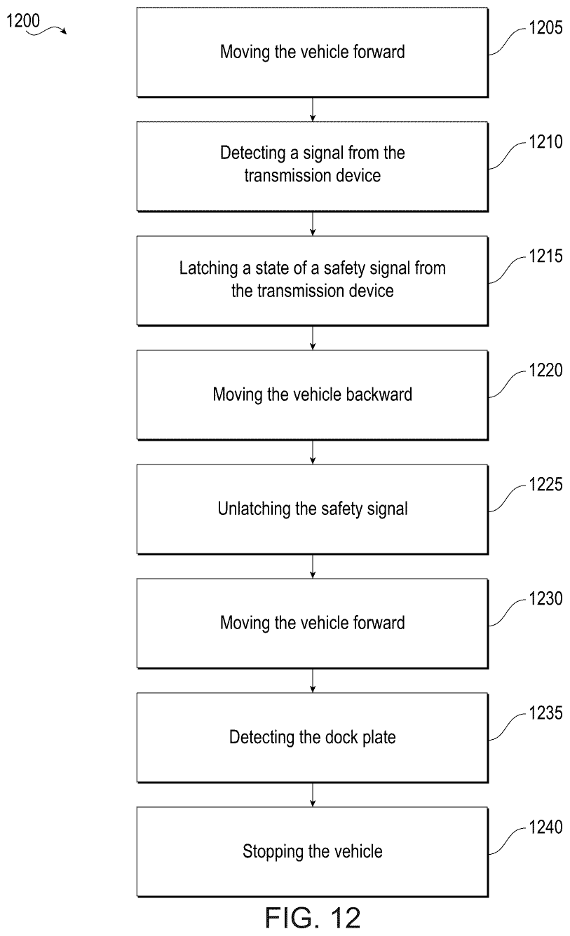

FIG. 12 depicts a flowchart 1200 for yet another technique for operating the vehicle subsystem 170 of the virtual safety gate 105. The technique of the flowchart 1200 is generally described as being performed by the vehicle subsystem 170. One or more parts of the virtual safety gate 105 and/or the vehicle subsystem 170, such as the vehicle controller 405 and/or another device, are configured to perform various parts of the techniques.

At stage 1205, the forklift 130 moves forward. Then at stage 1210, the vehicle subsystem 170 receives the safe to enter signal using the vehicle coupler 225. Then at stage 1215, the vehicle subsystem 170 latches the state of the safe to enter signal. The vehicle subsystem 170 performs the same actions at stage 1205, stage 1210, and stage 1215 as performed at stage 905, stage 910, and stage 915 in FIG. 9, and/or at stage 1005, stage 1010, and stage 1015 in FIG. 10. Up to stage 1215, the forklift 130 continues toward the monitored area 110. Further, the vehicle subsystem 170 receives and stores the safe to enter signal during this time.

At stage 1220, the forklift 130 begins moving backward, such as in the direction of the reverse arrow 705 in FIG. 7. The vehicle subsystem 170 controls the forklift 130 to move and/or observes the forklift 130 move in reverse. In most cases, the forklift 130 continues to move forward without stopping or reversing in the area between the entrance status coupler 220 and the entryway zone 120. However, in some cases, the forklift 130 moves in reverse. For example, the forklift 130 moves in reverse in response to safety inputs from other devices in the virtual safety gate 105, such as the head scanner 185. As another example, the forklift 130 moves in reverse due to controls from a human driver and/or from other systems in the facility. At stage 1225, the vehicle subsystem 170 unlatches the safe to enter signal. The vehicle subsystem 170 unlatches the signal after detecting the forklift 130 move in reverse. When forklift 130 moves in reverse, the vehicle subsystem 170 generally interprets that the operations of the forklift 130 have been interrupted. Such interruptions provide an opportunity for the human operator 135 to enter the monitored area 110 after the state of the safe to enter signal has been latched. If the human operator 135 enters the monitored area 110 in this window of time, and the forklift 130 begins traveling forward again, the human operator 135 is at risk to be injured and/or trapped by the forklift 130 in the monitored area 110. The vehicle subsystem 170 therefore unlatches the safe to enter signal at stage 1405 to ensure such scenarios do not occur.

At stage 1230, the forklift 130 begins moving forward again. For example, the interruption from stage 1220 has subsided and the forklift 130 is allowed to return to normal operations. The vehicle subsystem 170 then continues to stage 1235. When the forklift 130 reaches the dock plate 160, the vehicle subsystem 170 detects the dock plate 160 using the entryway zone detector 410. Then at stage 1240, the vehicle subsystem 170 evaluates the safety conditions. At stage 1235 and stage 1240, the vehicle subsystem 170 generally performs the same actions as at stage 920 through stage 935 in FIG. 9 and/or at stage 1035 and stage 1040 in FIG. 10. Because the vehicle subsystem 170 unlatches the safe to enter signal at stage 1225, the vehicle subsystem 170 determines that the conditions are unsafe. The vehicle subsystem 170 therefore commands the forklift 130 to stop. Preventing the forklift 130 from entering the monitored area 110 after the forklift 130 has reversed generally provides an additional layer of safety to the virtual safety gate 105. For example, stopping the forklift 130 in this way removes opportunities for the human operator 135 to enter the monitored area 110 after the safety status is set.

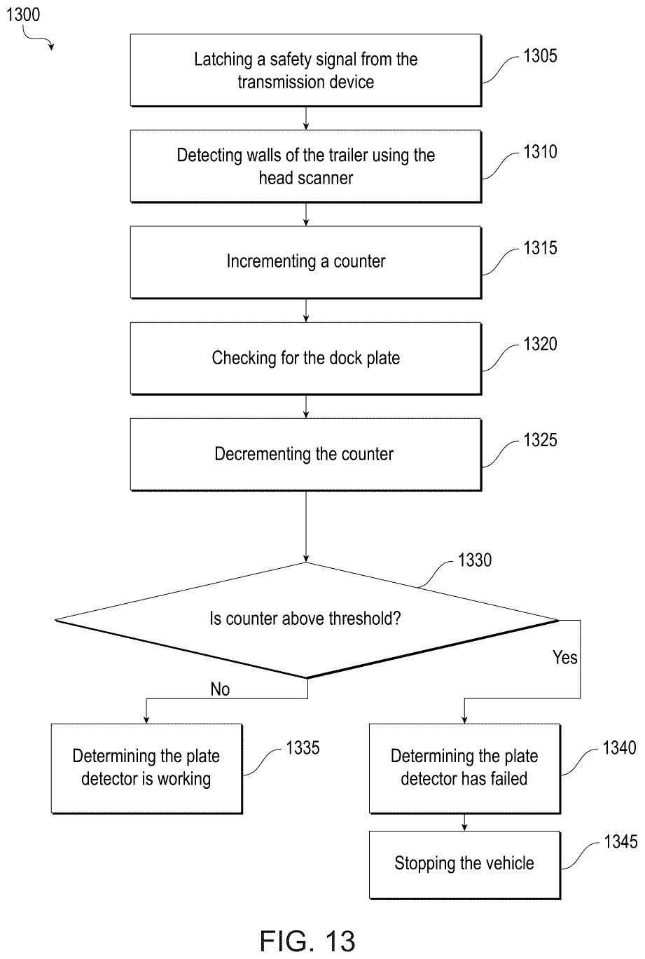

Referring to FIG. 13, a flowchart 1300 illustrates a technique for validating the function of the entryway zone detector 410. The virtual safety gate 105 generally performs the technique of the flowchart 1300 as a part of stage 825 in FIG. 8. As should be appreciated, one or more parts of the virtual safety gate 105 are configured to perform various parts of the technique in FIG. 13. Further, the technique is described using the plate detector 420. It should be appreciated that the technique is applicable to other forms of the entryway zone detector 410 and in other environments. At stage 1305, the virtual safety gate 105 latches the safe to enter signal. For instance, the virtual safety gate 105 performs the same actions as at stage 810 in FIG. 8, at stage 915 in FIG. 9, at stage 1015 in FIG. 10, and/or at stage 1215 in FIG. 12.

At stage 1310, the virtual safety gate 105 detects the walls of the trailer 155 using the head scanner 185. As should be appreciated, the virtual safety gate 105 is configured to use the head scanner 185 to detect features in the monitored area 110 in other environments, such as shelving and/or conveyor belts as examples. The head scanner 185 generally monitors the left trailer field 520 and the right trailer field 525 to check for the walls of the trailer 155. The virtual safety gate 105 then continues to stage 1315. Each time the virtual safety gate 105 detects one of the walls of the trailer 155, the virtual safety gate 105 increments a counter. In other words, when the virtual safety gate 105 detects either of the left wall and the right wall of the trailer 155, the virtual safety gate 105 adds one to the counter. The virtual safety gate 105 therefore increases the counter by two when detecting both sidewalls. In an alternate example, the virtual safety gate 105 detects additional features in the monitored area 110 and adds more than two to the counter.

At stage 1320, the virtual safety gate 105 checks for the dock plate 160 using the plate detector 420. The forklift 130 is positioned over the dock plate 160 when entering and when exiting the trailer 155. In one example, the virtual safety gate 105 performs the check at stage 1320 only when exiting the trailer 155. The virtual safety gate 105 then continues to stage 1325. When the virtual safety gate 105 detects the entryway zone 120, the virtual safety gate 105 decrements the counter. In other words, the virtual safety gate 105 subtracts one from the counter at this step. In one version, the virtual safety gate 105 is configured to check for the dock plate 160 using the plate detector 420. As should be appreciated, the virtual safety gate 105 is configured to check for another type of feature in the entryway zone 120 and/or validate a different type of entryway zone detector 410.

The virtual safety gate 105 then continues to stage 1330 to evaluate the counter. The virtual safety gate 105 compares the counter to a threshold. In the FIGS. 1 and 2 example, the threshold is one. The counter is expected to increase by two to show the two side walls of the trailer 155 being detected. The counter is expected to decrease by one to show the dock plate 160 being detected. When the forklift 130 is positioned in the entrance 115 at the trailer 155, the walls of the trailer 155 are in position for the head scanner 185 to detect and the dock plate 160 is in position for the plate detector 420 to detect. Therefore, setting the threshold to one allows the virtual safety gate 105 to check that the dock plate 160 was accurately detected when the plate detector 420 was above the dock plate 160. As should be appreciated, the threshold is set to a different value depending on the environment and the features of the monitored area 110 that are detected.

If the counter is at or below the threshold, the virtual safety gate 105 continues to stage 1335. As described, the counter being equal to the threshold suggests that the plate detector 420 worked as expected. In one example, the counter is at zero or below. In such an example, the virtual safety gate 105 determines that the head scanner 185 is not working correctly. Conversely, if the counter is above the threshold, the virtual safety gate 105 instead continues to stage 1340. Because the counter is above the threshold, the virtual safety gate 105 determines that the plate detector 420 did not detect the dock plate 160 and that the head scanner 185 detected the walls of the trailer 155. In one version, the virtual safety gate 105 continues to stage 1345. At stage 1345, the virtual safety gate 105 stops the forklift 130, such as in the same way as at stage 935 in FIG. 9 and/or at stage 1240 in FIG. 12. Stopping the forklift 130 in this way generally alerts the human operator 135 and/or other individuals that one or more components, particularly the plate detector 420, are not working. Alternatively or additionally, the virtual safety gate 105 sends a separate alert to another individual and/or system about the component failure. In either case, the virtual safety gate 105 assesses the functionality of various components in the virtual safety gate 105. Again, the virtual safety gate 105 provides reliable safety measures and meets Category 3 safety requirements by assessing component faults.

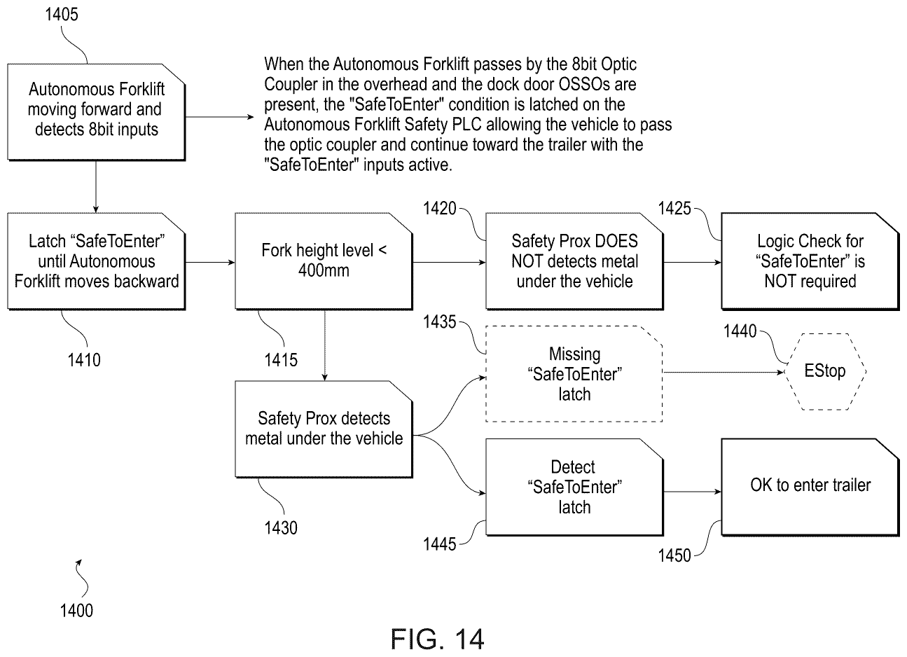

Referring to FIG. 14, a flowchart 1400 illustrates another example of a technique for protecting the human operator 135 from the forklift 130 in the monitored area 110. The technique is described as being performed by the vehicle controller 405. As noted, in one version, the vehicle controller 405 performs all the safety control and logic operations for the virtual safety gate 105. As should be appreciated, various parts of the virtual safety gate 105 and/or the vehicle subsystem 170 are configured to perform one or more parts of the technique. The technique of FIG. 14 involves various parts of the techniques illustrated in FIGS. 8-13.

At stage 1405, the forklift 130 moves forward and passes the entrance status coupler 220. The vehicle controller 405 receives the safe to enter signal input from the dock subsystem 165 through the vehicle coupler 225. The vehicle controller 405 then continues to stage 1410. At stage 1410, the vehicle controller 405 latches the safe to enter signal. If the forklift 130 moves backward, such as in the direction shown by the reverse arrow 705 in FIG. 7, the vehicle subsystem 170 unlatches the signal. The vehicle subsystem 170 then continues to stage 1415. At stage 1415, the vehicle controller 405 checks the height of the forks 190. As noted, the height of the forks 190 generally determines whether the head scanner 185 is available for the virtual safety gate 105 to use.

If the fork height is above 400 millimeters, the vehicle controller 405 allows the forklift 130 to continue forward. In this case, the head scanner 185 is not obstructed. The head scanner 185 is able to reliably detect the human operator 135 and/or other obstacles in the front field 540. The vehicle controller 405 continues to stage 1420. At stage 1420, the vehicle controller 405 does not require that the plate detector 420 detect the dock plate 160 as the forklift 130 moves forward. For example, the vehicle controller 405 does not need to assess the status of the monitored area 110 when the forklift 130 reaches the dock plate 160. Because the vehicle controller 405 utilizes the head scanner 185, checking for the dock plate 160 using the plate detector 420 is not necessary for safe operation. The vehicle controller 405 then continues to stage 1425. At stage 1425, the vehicle controller 405 determines that conditions are safe for the forklift 130 to enter into the monitored area 110. This is primarily due to the availability of the head scanner 185. Again, the head scanner 185 allows the forklift 130 to monitor the monitored area 110 and to avoid harming the human operator 135.

If the fork height is below 400 millimeters, the vehicle controller 405 continues to stage 1430. At stage 1430, the vehicle controller 405 checks for the dock plate 160 using the plate detector 420. The vehicle controller 405 waits until the dock plate 160 is detected while the forklift 130 moves forward. When the forklift 130 is at the dock plate 160, the vehicle controller 405 checks the state of the safe to enter signal. If the safe to enter signal is not latched, the vehicle controller 405 continues to stage 1435. At stage 1435, the vehicle controller 405 observes the missing safe to enter signal and determines that conditions are not safe for the forklift 130 to continue operating. The vehicle controller 405 then continues to stage 1440. At stage 1440, the vehicle controller 405 commands the forklift 130 to stop. Further, the vehicle controller 405 activates the indicator 305 and waits for a reset input via the manual control 180.

If the safe to enter signal is latched at stage 1430, the vehicle controller 405 continues to stage 1445. At stage 1445, the vehicle controller 405 observes the latched safe to enter signal. The latched safe to enter signal generally indicates that there is no human operator 135 in the monitored area 110. The vehicle controller 405 determines that conditions are safe for the forklift 130 to enter the monitored area 110. The vehicle controller 405 then continues to stage 1450. At stage 1450, the vehicle controller 405 allows the forklift 130 to continue because conditions in the monitored area 110 are safe. Using this technique allows the virtual safety gate 105 to ensure that the human operator 135 stays safe even when other safety measures, such as the head scanner 185, are not available.

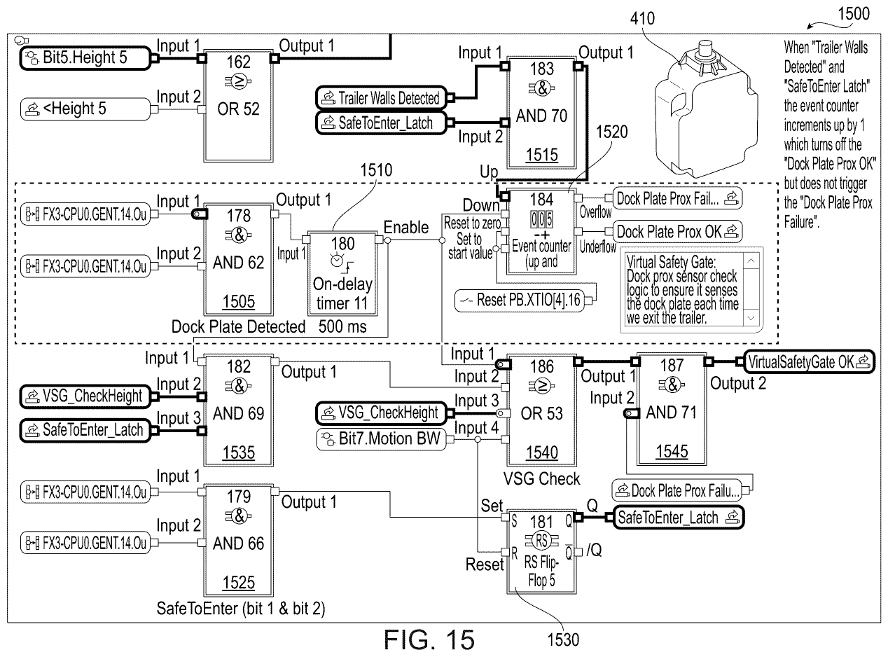

FIGS. 15, 16, 17, 18, 19, 20 and 21 show diagrams of a logic architecture 1500 used by the virtual safety gate 105 according to one example. The diagrams show various signals in different states as the virtual safety gate 105 operates. The logic architecture 1500 is implemented using hardware and/or software on the virtual safety gate 105. For instance, the logic architecture 1500 is implemented through software on the vehicle controller 405. For the purpose of explanation, the logic architecture 1500 is described for use in the loading dock 150. The logic architecture 1500 includes multiple devices such as logic gates, timers, and/or flip-flops. In the illustrated example, the logic architecture 1500 includes an entryway signal gate 1505, a timer 1510, a trailer wall signal gate 1515, a counter 1520, a safety signal gate 1525, a latch 1530, a preliminary safety condition gate 1535, a primary safety condition gate 1540, and a secondary safety condition gate 1545. Various parts of the techniques from FIGS. 8-13 are performed using the parts of the logic architecture 1500.

The entryway signal gate 1505 receives output signals from the entryway zone detector 410. In the illustrated example, the entryway signal gate 1505 receives two complimentary signals from the entryway zone detector 410. In other words, one signal is inverted relative to the other signal. The entryway signal gate 1505 is typically an AND gate that ensures that both output signals are received from the entryway zone detector 410. The output of the entryway signal gate 1505 is connected to the timer 1510. The timer 1510 delays the signal from the entryway signal gate 1505 to account any momentary false triggers by the entryway zone detector 410. For instance, small pieces of metal on the facility floor often momentarily trigger the entryway zone detector 410. The delay from the timer 1510 prevents those triggers from being sent to the other parts of the logic architecture 1500. The output of the timer 1510 then connects to a down-count input on the counter 1520. Conversely, the trailer wall signal gate 1515 connects to an up-count input on the counter 1520. The trailer wall signal gate 1515 receives wall detection signals from the head scanner 185. Additionally, the trailer wall signal gate 1515 receives the safe to enter signal that indicates whether the monitored area 110 is safe to enter. The trailer wall signal gate 1515 is typically an AND gate that checks for both the wall detection signal and the safe to enter signal. When both signals are present, the trailer wall signal gate 1515 provides an output to the counter 1520. The counter 1520 then counts up when receiving an input from the trailer wall signal gate 1515 and counts down when receiving an input from the timer 1510. The virtual safety gate 105 uses the counter 1520 to perform one or more of the actions from stage 1315, stage 1325, stage 1330, stage 1335, and stage 1340 in FIG. 13. If the counter 1520 determines the entryway zone detector 410 is not functioning properly, the counter 1520 outputs a plate detector failure signal to the secondary safety condition gate 1545.

The safety signal gate 1525 receives the safe to enter signal from the vehicle coupler 225. In the illustrated example, the safety signal gate 1525 receives the signal via two channels as redundant inputs. As noted, the redundant inputs ensure the virtual safety gate 105 functions reliably. The safety signal gate 1525 is typically an AND gate that checks that both safe to enter signal inputs are received. The output of the safety signal gate 1525 connects to an input on the latch 1530. The virtual safety gate 105 uses the latch 1530 to latch the safe to enter signal, such as at stage 810 in FIG. 8, stage 915 in FIG. 9, and/or stage 1015 in FIG. 10. The latch 1530 is further configured to receive a reset input when the forklift 130 moves in reverse. The latch 1530 unlatches the safe to enter signal upon receiving the reset signal. As long as the safe to enter signal is latched, the latch 1530 outputs the latched signal to the preliminary safety condition gate 1535.

The preliminary safety condition gate 1535 checks for a combination of conditions that indicate that the forklift 130 is safe to enter into the monitored area 110. As noted, the preliminary safety condition gate 1535 receives the latched safe to enter signal from the latch 1530. Further, the preliminary safety condition gate 1535 receives a fork height signal that indicates that the forks 190 are below the threshold height. Finally, the preliminary safety condition gate 1535 receives the output from the timer 1510 when the entryway zone detector 410 senses the dock plate 160. The preliminary safety condition gate 1535 is an AND gate that checks for all three conditions before providing a positive output to the primary safety condition gate 1540.

The primary safety condition gate 1540 generally checks for all the allowable conditions for the forklift 130 continue operating. First, based on the signal received from the timer 1510, the primary safety condition gate 1540 checks that the dock plate 160 has not been detected. If the forklift 130 is not at the dock plate 160, the virtual safety gate 105 allows the forklift 130 to continue moving forward. Second, the primary safety condition gate 1540 checks for the combination of conditions evaluated by the preliminary safety condition gate 1535. When that combination of conditions is met, the virtual safety gate 105 allows the forklift 130 to proceed into the monitored area 110. Third, the primary safety condition gate 1540 checks that the height of the forks 190 is above the threshold height. The virtual safety gate 105 allows the forklift 130 to enter the monitored area 110 and to rely on the head scanner 185 in this case. Finally, the primary safety condition gate 1540 receives an input when the forklift 130 moves in reverse. When the forklift 130 moves in reverse, the virtual safety gate 105 allows the forklift 130 to continue operating. However, in that case, the other necessary safety conditions are typically reset before the forklift 130 attempts to enter the monitored area 110. The primary safety condition gate 1540 is an OR gate that checks for any of the listed conditions to be met before sending a signal to the secondary safety condition gate 1545. The secondary safety condition gate 1545 checks for the signal from the primary safety condition gate 1540 and for the plate detector failure signal from the counter 1520. If the input signal from the primary safety condition gate 1540 is positive and the plate detector failure signal is not present, then the secondary safety condition gate 1545 outputs an affirmative safety gate signal that indicates the forklift 130 is safe to continue operating. When the virtual safety gate 105 does not observe the affirmative safety gate signal, the virtual safety gate 105 commands the forklift 130 to stop until the virtual safety gate 105 is reset and/or until the affirmative safety gate signal is observed.

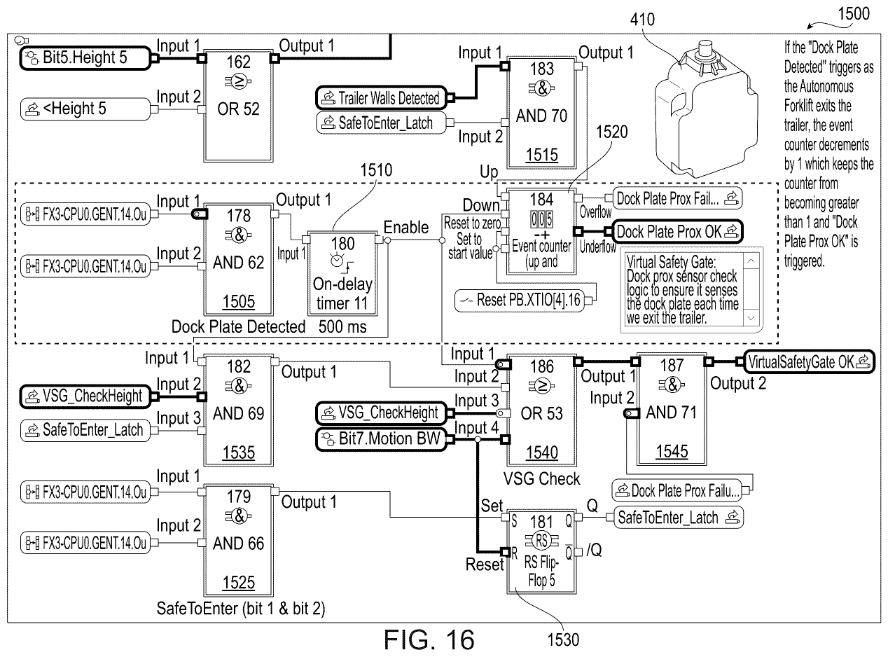

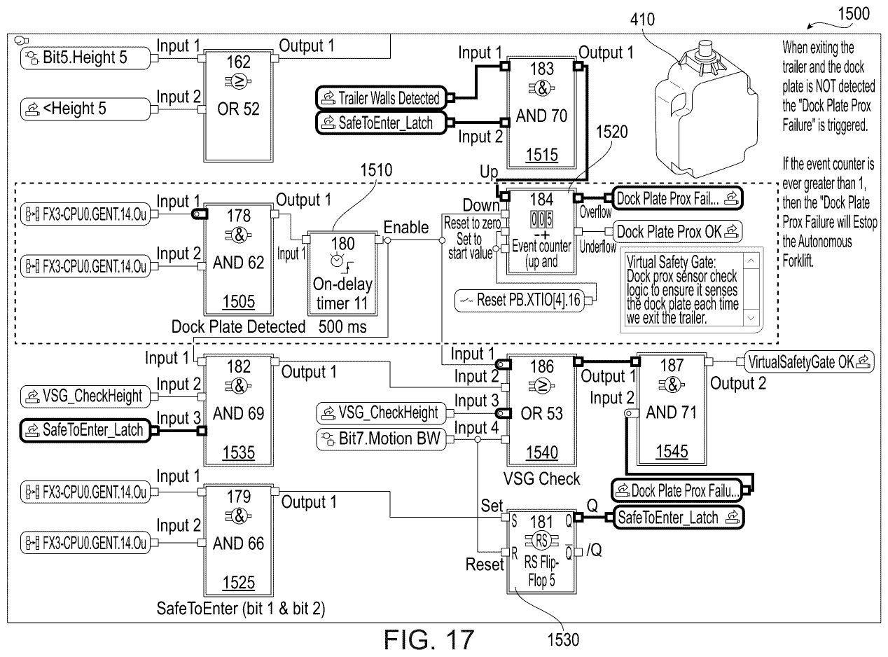

FIGS. 15-17 illustrate the change in signals through the logic architecture 1500 as the virtual safety gate 105 validates the function of the entryway zone detector 410. In FIG. 15, the head scanner 185 detects one of the walls of the trailer 155 and the safe to enter signal is positive (i.e., the monitored area 110 is safe for the forklift 130). In this case, the trailer wall signal gate 1515 provides an input signal to the counter 1520 to add one. At this point, the counter value is still below the threshold. Therefore, the counter 1520 does not output the plate detector failure signal yet. In the FIG. 16 example, the entryway zone detector 410 detects the dock plate 160. Complimentary output signals from the entryway zone detector 410 are sent to the entryway signal gate 1505, then to the timer 1510 as a single signal, and then to the down input of the counter 1520. The counter value is then decreased by one. At this time, the head scanner 185 detects the remaining wall of the trailer 155 and increases the counter value again. The result is that the counter value is at the threshold. In this case, the counter 1520 outputs a signal indicating that the entryway zone detector 410 is functioning properly. Conversely, in the FIG. 17 example, the entryway zone detector 410 does not detect the dock plate 160. Therefore, the counter value stays above the threshold and does not decrease. In this case, the counter 1520 outputs the plate detector failure signal.

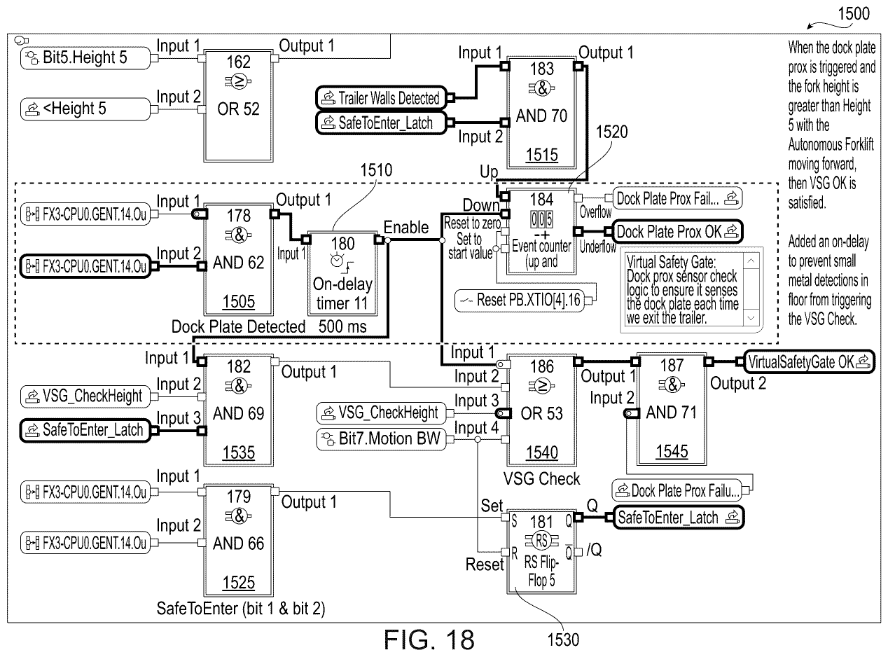

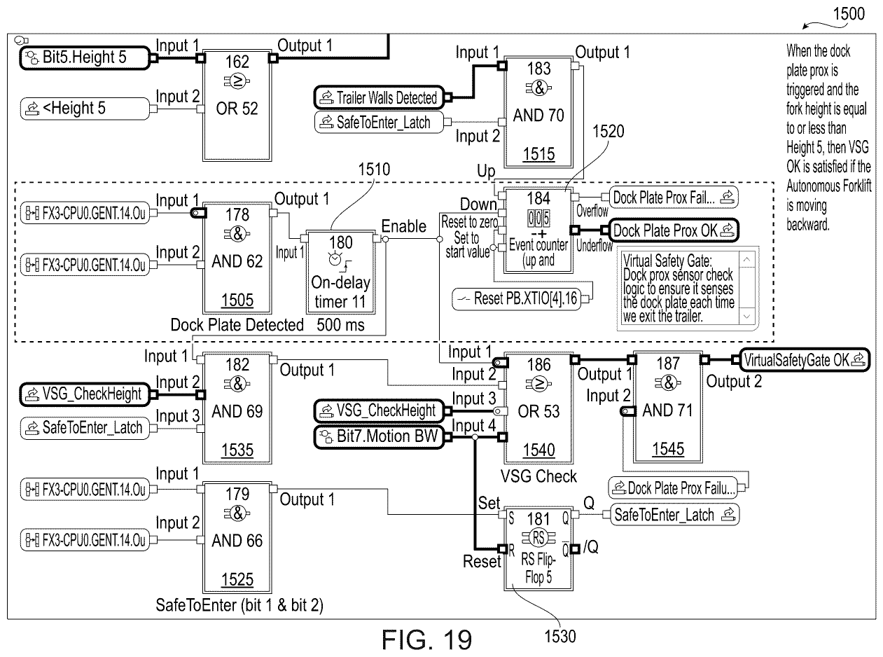

FIGS. 18-21 illustrate changes in signals through the logic architecture 1500 during the normal operation of the virtual safety gate 105. As shown in FIG. 18, the secondary safety condition gate 1545 outputs the affirmative safety gate signal when the height of the forks 190 is above the threshold height. As noted, the head scanner 185 is not obstructed and able to monitor the surroundings for the human operator 135 in this case. In the FIG. 19 example, the secondary safety condition gate 1545 still outputs the affirmative safety gate signal when the forklift 130 is moving backward even if other conditions are not met. In this example, the height of the forks 190 is below the threshold and the dock plate 160 is not detected. These conditions are necessary in some cases to allow the forklift 130 to enter the monitored area 110. However, when the forklift 130 is reversing, the safe to enter signal is unlatched. Under such conditions, the virtual safety gate 105 typically only allows the forklift 130 to enter the monitored area 110 if the head scanner 185 is unobstructed and/or if the virtual safety gate 105 is reset.

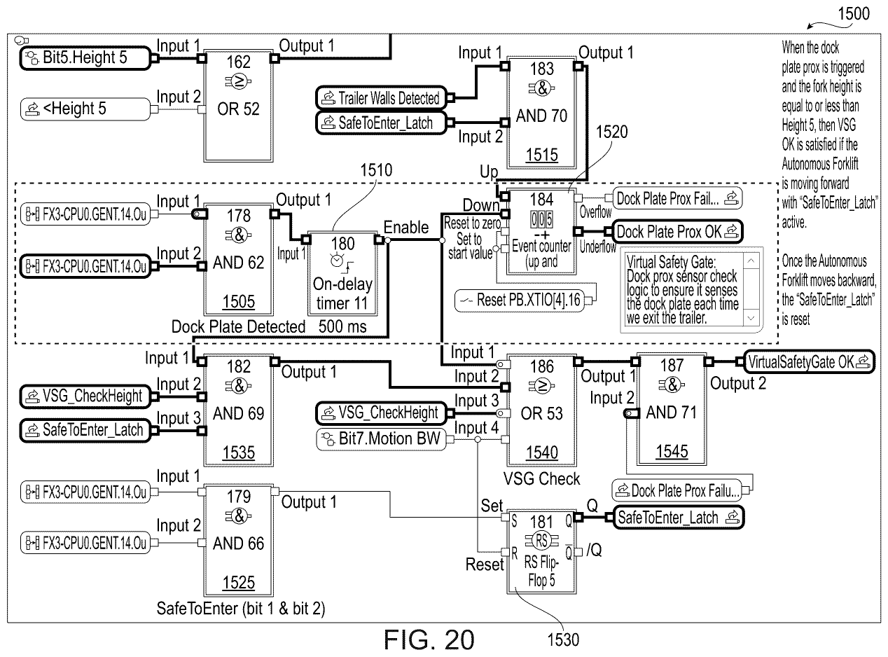

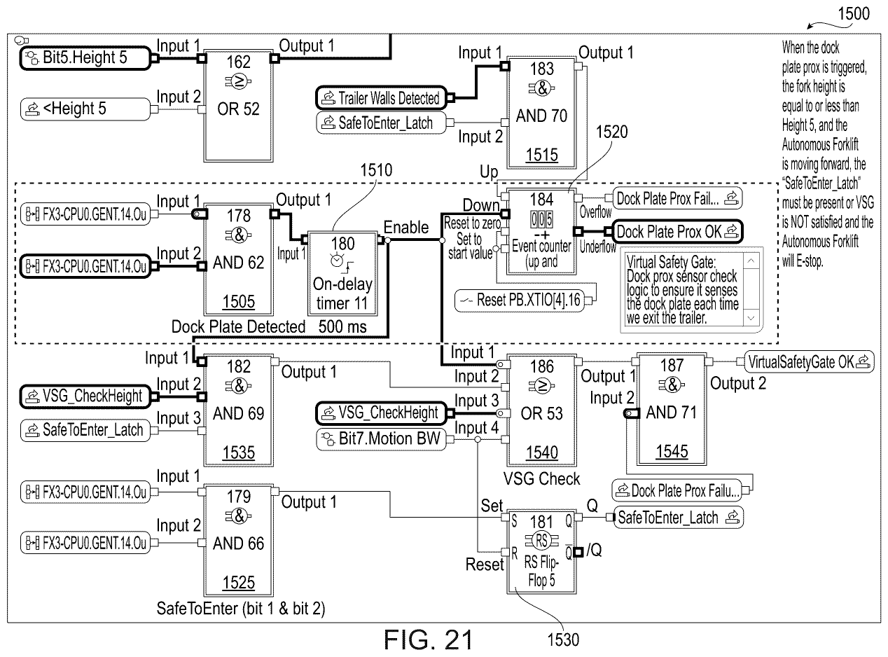

In FIG. 20, the conditions evaluated at the preliminary safety condition gate 1535 are all met. Therefore, the secondary safety condition gate 1545 outputs the affirmative safety gate signal and the virtual safety gate 105 allows the forklift 130 to enter the monitored area 110. As shown, the height of the forks 190 is below the threshold height, meaning the head scanner 185 is blocked. The entryway zone detector 410 senses the dock plate 160. The safe to enter signal is latched and positive. These conditions indicate that the monitored area 110 is clear of the human operator 135. Conversely, in FIG. 21, the safe to enter signal is not latched. Because the head scanner 185 is obstructed and the virtual safety gate 105 has detected the human operator 135 in the monitored area 110, the secondary safety condition gate 1545 does not output the affirmative safety gate signal. The virtual safety gate 105 therefore commands the forklift 130 to stop.

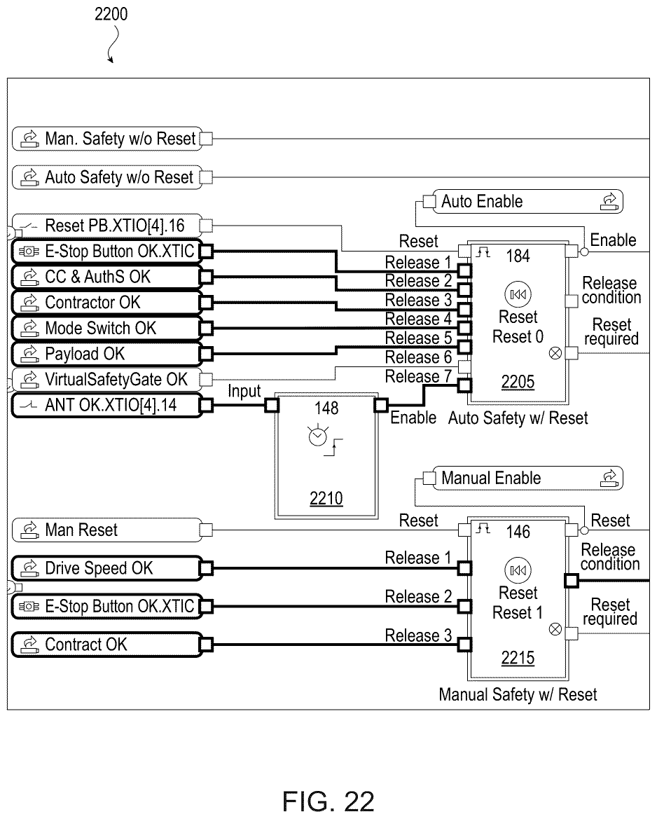

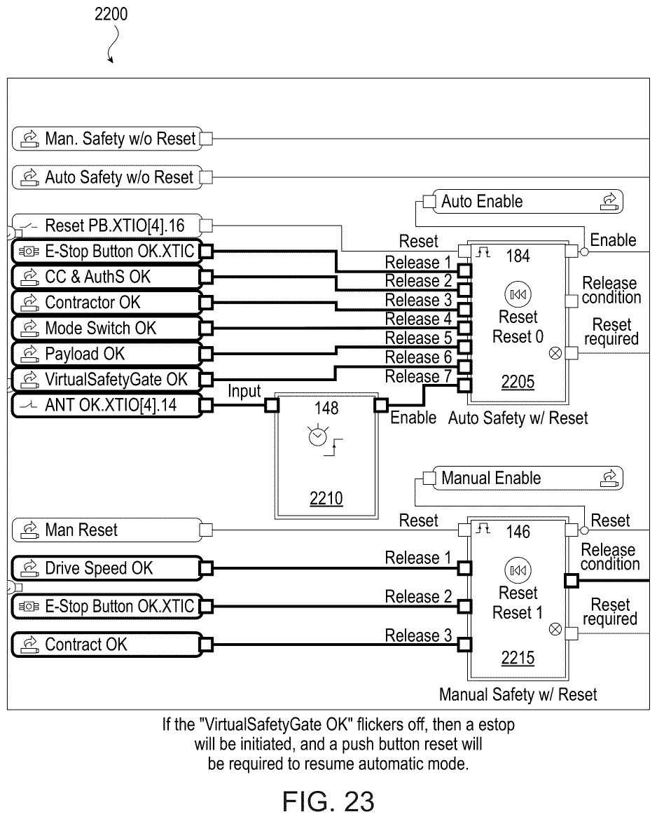

FIGS. 22 and 23 depict diagrams of another example of a logic architecture 2200 used by the virtual safety gate 105. The diagrams show various signals in different states as the virtual safety gate 105 operates. In one example, the logic architecture 2200 is implemented on the virtual safety gate 105 in the same way as the logic architecture 1500. One or more parts of the logic architecture 2200 interface and/or communicate with one or more parts of the logic architecture 1500. The logic architecture 2200 includes multiple devices such as logic gates, timers, and/or flip-flops. In the illustrated example, the logic architecture 2200 includes an automated reset gate 2205, a timer 2210, and a manual reset gate 2215. Various parts of the techniques from FIGS. 8-13 are performed using the parts of the logic architecture 2200.

The automated reset gate 2205 checks for various conditions during the operation of the virtual safety gate 105. If the conditions are not met, the automated reset gate 2205 initiates the safety command for the forklift 130 to stop. In the illustrated example, one or more signals being sent to the automated reset gate 2205 pass through the timer 2210. The timer 2210 delays the signals momentarily to avoid false triggers. The automated reset gate 2205 receives the safety gate signal from the secondary safety condition gate 1545 from FIG. 15. As shown in FIG. 22, if the automated reset gate 2205 does not receive an affirmative safety gate signal, the automated reset gate 2205 initiates the stop. Even if the safety gate signal momentarily flickers off, the automated reset gate 2205 still initiates the stop command. By not passing the safety gate signal through the timer 2210, the automated reset gate 2205 is able to react to these momentary flickers. In the FIG. 23 example, the automated reset gate 2205 receives the affirmative safety gate signal and does not initiate a stop command for the forklift 130. Further, the manual reset gate 2215 checks for inputs from manual feedback devices, such as a physical stop button and/or devices. The manual reset gate 2215 initiates a stop command for the forklift 130 upon receiving one or more of such inputs.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below. “And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well. “Architecture Category” or “Safety Category” generally refers to a categorization of a machinery control system based on safety and fault-tolerance. According to some schemes, such as ANSI/ISO standard 13849, the architecture categories include B, 1, 2, 3, and 4 arranged from least to most protective. Category B and 1 architectures generally utilize rely on failure resistance of components in the system. Category 2 safety generally includes checking for faults periodically. Category 3 safety similarly involves monitoring for faults. Category 3 builds on Category 2 by utilizing redundant components and/or multiple signal channels for additional security. The redundancy ensures that no single component causes a system failure. Category 4 builds on Category 3 by utilizing components with a low failure rate. In some contexts, Category 3 architecture refers to both Category 3 and Category 4 design. For example, a Category 3system that utilizes high-reliability, low-failure components is effectively a Category 4 system.

“Automated Guided Vehicle” (AGV) or “Autonomous Mobile Unit” (AMU) generally refers to a mobile robot that is able to automatically self-navigate between various locations. For example, AGVs are typically, but not always, able to automatically navigate by following markers, such as wires or magnets embedded in the floor, by using lasers, and/or by using one or more vision systems. AGVs are also typically, but not always, designed to automatically avoid collisions, such as with other AGVs, equipment, and personnel. AGVs are commonly, but not always, used in industrial applications to move materials around a manufacturing facility or warehouse.

“Autonomous Forklift” or “Automated Guided Forklift (AGF)” generally refers to a driverless forklift that can move and lift materials without human intervention. Commonly, autonomous forklifts use sensors, cameras, and/or artificial intelligence to navigate. The autonomous forklifts usually follow a series of instructions to move around a space and perform task, and the autonomous forklifts typically are able to communicate with other vehicles and systems.

“Computer” generally refers to any computing device configured to compute a result from any number of input values or variables. A computer may include a processor for performing calculations to process input or output. A computer may include a memory for storing values to be processed by the processor, or for storing the results of previous processing. A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network interface to perform various network communications upon request. A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. A computer may include one or more physical processors or other computing devices or circuitry and may also include any suitable type of memory. A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer. The concept of “computer” and “processor” within a computer or computing device also encompasses any such processor or computing device serving to make calculations or comparisons as part of a disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

“Controller” generally refers to a device, using mechanical, hydraulic, pneumatic electronic techniques, and/or a microprocessor or computer, which monitors and physically alters the operating conditions of a given dynamical system. For example, the controller may be configured to control the behavior of another mechanical and/or electronic device. A controller may include a “control circuit” configured to provide signals or other electrical impulses that may be received and interpreted by the controlled device to indicate how the controlled device should behave. A controller may include a processor for performing calculations to process input or output. A controller may include a memory for storing values to be processed by the processor, or for storing the results of previous processing. A controller may also be configured to accept input and output from a wide array of input and output devices for receiving or sending values. A controller may also be a virtual computing platform having an unknown or fluctuating number of physical processors and memories or memory devices. A controller may thus be physically located in one geographical location or physically spread across several widely scattered locations with multiple processors linked together by a communication network to operate as a single controller. Multiple controllers or computing devices may be configured to communicate with one another or with other devices over wired or wireless communication links to form a network.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour. Data may be organized and represented in a structured format. Examples include a tabular representation using rows and columns, a tree representation with a set of nodes considered to have a parent-children relationship, or a graph representation as a set of connected nodes to name a few. The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Forklift Truck”, “Forklift”, or “Fork Truck” generally refers to a vehicle with one or more prongs, blades, forks, or other parts that can be slid into or under loads and then raised or lowered in order to move and/or stack the loads. In a common arrangement, the forklift truck has two forks that can be slid into a pallet that carries a load. The forks are typically raised and lowered along a forklift mast. In certain designs, the mast and/or forks can be tilted so as to better retain the carried load. The forklift truck can be operated by a human operator, semi-autonomously controlled, or even fully autonomous. In one example of a fully autonomous design, the forklift truck is an Autonomously Guided Vehicle (AGV). Forklift trucks can be used in a wide variety of environments, such as in warehouses, lumberyards, manufacturing plants, and shipping depots, to name just a few examples. The forklift trucks can be powered in several manners, such as by using internal combustion engines (e.g., with liquefied petroleum gas, or LPG), via battery-electric powerplants, and/or hydrogen fuel cells. Some non-limiting forklift truck design types include low lift trucks, stackers, reach trucks, side loaders, order-picking trucks, guided very-narrow-aisle trucks, articulated counterbalance trucks, and omnidirectional trucks, to name just a few.

“Guidance, Navigation, and Control (GNC) System” generally refers to a physical device, a virtual device, and/or a group of devices configured to control the movement of vehicles, such as automobiles, automated guided vehicles, ships, aircraft, drones, spacecraft, and/or other moving objects. GNC systems are typically configured to determine a desired path of travel or trajectory of the vehicle from the vehicle's current location to a designated target, as well as desired changes in velocity, rotation, and/or acceleration for following the path. The GNC system can include and/or communicate with sensors like compasses, GPS receivers, Loran-C, star trackers, inertial measurement units, altimeters, environmental sensors, and the like. At a given time, such as when the vehicle is travelling, the GNC system is configured to determine the location (in one, two, or three dimensions) and velocity of the vehicle. For example, the GNC system is able to calculate changes in position, velocity, attitude, and/or rotation rates of a moving vehicle required to follow a certain trajectory and/or attitude profile based on information about the state of motion of the vehicle. The GNC system is able to maintain or change movement of the vehicle by manipulating forces by way of vehicle actuators, such as steering mechanisms, thrusters, flaps, etc., to guide the vehicle while maintaining vehicle stability. GNC systems can be found in autonomous or semi-autonomous vehicles.

“Item” generally refers to an individual article, object, or thing. Commonly, but not always, items are handled in warehouse and material handling environments. The item can come in any form and can be packaged or unpackaged. For instance, items can be packaged in cases, cartons, bags, drums, containers, bottles, cans, pallets, and/or sacks, to name just a few examples. The item is not limited to a particular state of matter such that the item can normally have a solid, liquid, and/or gaseous form for example.

“Lidar” or “Laser Imaging, Detection, and Ranging” generally refers to a device and/or method for determining distances to objects by shining a laser beam at the object or surface and measuring the time for the reflected light to return to the device. Lidar operates in a manner similar to radar, but the lidar device emits pulsed laser light instead of radio waves or microwaves. Lidar is commonly used to make high resolution three-dimensional maps in a wide variety of applications, like for surveying, forestry, and autonomous vehicle operations.

“Light” generally refers to electromagnetic radiation having any wavelength. Among other examples, light includes visible light, infrared, ultraviolet, gamma rays, X-rays, microwaves, and radio waves.

“Line of Sight Communication” or “LOS Communication” generally refers a method of transmitting data between two points that requires a direct, unobstructed path between a transmitter and a receiver. Some common LOS communication techniques are used in radio frequency (RF) communication. Some nonlimiting examples of LOS communications include microwave communication, line-of-sight radio communication, infrared (IR) communication, laser communication, and visible light communication (VLC) techniques. LOC communications can further utilize acoustic waves.

“Line of Sight Propagation” or “LOS Propagation” generally refers a characteristic of electromagnetic or acoustic waves where the waves can only travel in a direct path from a source to a receiver without obstacles. As an example of LOS propagation for electromagnetic radiation, the electromagnetic waves are transmitted directly from a transmitting antenna (or other electromagnetic source) to a receiving antenna (or other electromagnetic receiver) without significant interference from obstacles.

“Loading Dock” or “Loading Bay” generally refers to an area of a building or other structure where cargo items for cargo carriers (usually, but not always, road, rail, or sea) are loaded and unloaded. Cargo items can be also staged at the loading dock. Loading docks are commonly found on commercial and industrial buildings, and warehouses in particular. Loading docks may be exterior, flush with the building envelope, or fully enclosed. Loading docks are not just limited to fully enclosed buildings, but instead, can be located at locations that are partially or fully open to the outside environment. A loading dock commonly, but not always, includes a dock leveler, a dock plate/board, a dock seal/shelter, one or more dock bumpers, one or more vehicle restraints, dock lights or lighting, a dock doorway, one or more dock doors, and/or a dock pit. The dock leveler usually functions as a bridging device that adjusts to the varying heights of truck/trailer beds so as to facilitate easy loading and unloading. The dock pit is normally a recessed area in the floor where the dock leveler is installed. The dock plate or dock board is commonly incorporated into the dock lift, but it sometimes can be a separate portable device. The dock plate or dock board spans the gap and adjusts for elevation differences between the loading dock/warehouse floor and the trailer/truck bed. The dock plate is commonly made from metal such as steel and/or aluminum, and the dock plate typically includes a diamond pattern embossing on the outer surface to enhance traction. The dock seal or shelter is usually an inflatable or fabric structure that creates a barrier between the dock and trailer so as to reduce drafts and provide protection from the elements. Dock bumpers are usually made of rubber so as to absorb the impact when the truck or trailer backs into the loading dock. The vehicle restraints, such as wheel cocks, hooks, and arm restraints, are configured to secure the trailer or truck in place during loading and unloading so as to prevent trailer creep. The dock doors are able to open and close the doorway of the loading dock. The dock doors for example can include rolling, sectional, or vertical lift type doors.

“Metallic” generally refers to a material that includes a metal or is predominately (50% or more by weight) a metal. A metallic substance may be a single pure metal, an alloy of two or more metals, or any other suitable combination of metals. The term may be used to refer to materials that include nonmetallic substances. For example, a metallic cable may include one or more strands of wire that are predominately copper sheathed in a polymer or other nonconductive material.

“Network” or “Computer Network” generally refers to a telecommunications system that allows computers or other electronic devices to exchange data. Computers can pass data to each other along data connections by transforming data into a collection of datagrams or packets. The connections between computers and the network may be established using either cables, optical fibers, or via electromagnetic transmissions such as for wireless network devices. Computers coupled to a network may be referred to as “nodes” or as “hosts” and may originate, broadcast, route, or accept data from the network. Nodes can include any computing device such as personal computers, phones, and servers as well as specialized computers that operate to maintain the flow of data across the network, referred to as “network devices”. Two nodes can be considered “networked together” when one device is able to exchange information with another device, whether or not they have a direct connection to each other. A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

“Operatively Coupled” generally refers to a connection where at least two devices and/or structures are directly or indirectly connected to communicate with one another, be secured together, and/or function together. For instance, the devices can be connected through a wired and/or wireless connection in order to exchange data, commands, and/or other types of information. The devices can be directly connected together or indirectly connected together through a third-party device. In one case, electrical current can flow between the devices through electrically conductive wire, and in other cases, other types of electromagnetic radiation, such as visible light and radio waves, can be exchanged through various media, such via fiber optic cable. When operatively coupled, the devices and/or structures can be physically connected to one another via a direct connection or an indirect connection, such as via fasteners, adhesives, and/or mechanical linkages, to name just a few examples.

“Optic Coupler” or “Optical Data Transmitter” generally refers to a device that communicates wirelessly by emitting and/or receiving pulses and/or beams of light. Optic couplers typically use infrared, ultraviolet, visible light, and/or other frequencies of light. Typically, optic couplers are arranged in a pair with one optic coupler sending and/or receiving data to another optic coupler. In some arrangements, one optic coupler is configured to only transmit data and the other optic coupler is configured to only receive data. In other arrangements, each optic couple is configured as a transceiver that can transmit and receive data with the other optic coupler. Optic couplers can send/receive data in various forms, such as a single binary signal, multiple binary signals, an analog signal, and/or other ways. For instance, some optic couplers send and/or receive data via multiple beams of light simultaneously with each beam carrying a separate bit or string of bits of the data. Generally, a pair of optic couplers are aligned such that the light emitted from one optic coupler is aimed toward a light receiving area on the other optic coupler.

“Performance Level (PL)” or “Required Performance Level (PLr)” generally refers to a measure of the safety functionality of a machinery control system. Typically, performance level is used to evaluate the safety of systems that involve both humans and robots, such as human-in-the-loop systems and/or other mixed systems. A required performance level more specifically denotes a minimum level of safety functionality required for a particular system. According to some safety schemes, such as ANSI/ISO standard 13849, there are five performance levels labeled “a” through “e” (e.g., “PLa,” “PLb,” “Plc,” etc.). PLa denotes the lowest performance (i.e., least safe) while PLe denotes the highest performance (i.e., most safe). The performance level more specifically denotes the probability of a dangerous failure per hour in the control system. For example, a PLa system has between 0.001% and 0.01% chance of a dangerous failure per hour. Conversely, a PLe system has a much lower chance of dangerous failure per hour between 0.000001% and 0.00001%. In the middle, a PLc system has a chance between 0.0001% and 0.0003% of a dangerous failure per hour. In some examples, the performance level of a system is determined by considering first the severity of potential injuries, then the frequency and/or exposure to hazards, and finally the possibility of avoiding or limiting the harm. Specifically, the performance level is determined based on whether the injury is more severe or less severe, whether the frequency and/or exposure is high or low, and whether the possibility to avoid the harm is high or low. Further, in some examples, a safety category is assigned to the system to in combination with the performance level.

“Photoeye”, “PE”, or “Photoelectric Sensor” generally refers to a device configured to detect the presence, absence, and/or distance of an object with a light transmitter (or emitter) and a photoelectric receiver. In one form, the emitter and receiver are integrated to form a single unit, and in another form, the emitter and receiver are separate components. Photoeyes can be generally categorized into three different types, opposed (through-beam), retro-reflective, and proximity-sensing (diffused) types.

“Proximity Sensor” generally refers to a non-contact device that detects the presence, absence, and/or changes in proximity of an object. The proximity sensor can utilize various technologies to emit a signal, such as an electromagnetic field, sound waves, or light, and then analyzes the changes in that signal caused by the presence of the object. This technique allows the proximity sensor to determine the nearness of the object without physically touching the object. Some common types of proximity sensors include capacitive proximity sensors, inductive proximity sensors, sonic proximity sensors, and photoelectric proximity sensors, to name just a few examples.

“Receive” generally refers to accepting something transferred, communicated, conveyed, relayed, dispatched, or forwarded. The concept may or may not include the act of listening or waiting for something to arrive from a transmitting entity. For example, a transmission may be received without knowledge as to who or what transmitted it. Likewise the transmission may be sent with or without knowledge of who or what is receiving it. To “receive” may include, but is not limited to, the act of capturing or obtaining electromagnetic energy at any suitable frequency in the electromagnetic spectrum. Receiving may occur by sensing electromagnetic radiation. Sensing electromagnetic radiation may involve detecting energy waves moving through or from a medium such as a wire or optical fiber. Receiving includes receiving digital signals which may define various types of analog or binary data such as signals, datagrams, packets and the like.

“Robot” generally refers to a machine, such as one programmable by a computer, capable of carrying out a complex series of actions automatically. Sometimes, but not always, the robot automatically performs complicated, often repetitive tasks. Occasionally, the robot resembles all or part of a living creature that is capable of moving independently and/or performing complex actions such as grasping and moving objects. A robot can be guided by an external control device, or the control may be embedded within the robot.

“Safety Command” generally refers to a request for an action to be performed that prevents imminent harm or damage to a human, a piece of equipment, and/or a structure. The safety command can be communicated in a number of forms such as in verbal, written, symbolic, and/or electronic forms. Some non-limiting examples, of safety commands include the words “stop”, “halt”, “turn”, “back up”, “reverse”, or “slow down” to name just a few.

“Scanner” or “Safety Scanner” generally refers to a device that observes or scans an area and detects when a person and/or object enters the area. Scanners are commonly used in automated parts of factories and warehouses to protect personnel from injury caused by machines and/or other hazards. Scanners generally utilize one or more sensors, such as laser sensors, proximity sensors, LIDAR, and/or computer vision systems as some examples. Particularly, some common forms of safety scanners utilize one or more lasers to scan the area. For example, such scanners use many lasers arranged around an arc to scan an area extending radially around the scanner. Further, some scanners allow the shape of the scanned area to be customized, such as by customizing the physical arrangement of lasers and/or using software. In some cases, scanners are configured to detect objects having a particular shape. For instance, some scanners are configured to identify particularly dangerous objects and/or to ignore certain objects that are not dangerous. To ensure safety and high reliability, many safety scanners monitor internal function and utilize redundant sensing signals.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Signal” generally refers to a function or means of representing information. It may be thought of as the output of a transformation or encoding process. The concept generally includes a change in the state of a medium or carrier that conveys the information. The medium can be any suitable medium such as air, water, electricity, magnetism, or electromagnetic energy such as in the case of radio waves, pulses of visible or invisible light, and the like. As used herein, a “signal” implies a representation of meaningful information. Arbitrary or random changes in the state of a carrier medium are generally not considered “signals” and may be considered “noise”. For example, arbitrary binary data streams are not considered as signals. On the other hand, analog and digital signals that are representations of analog physical quantities are examples of signals. A signal is commonly not useful without some way to transmit or send the information, and a receiver responsive to the transmitter for receiving the information. In a communication system, for example, a transmitter encodes a message to a signal, which is carried to a receiver by the communications channel. For example, the words “The time is 12 o'clock” might be the message spoken into a telephone. The telephone transmitter may then convert the sounds into an electrical voltage signal. The signal is transmitted to the receiving telephone by wires, at the receiver it is reconverted into sounds. Signals may be thought of as “discrete” or “continuous.” Discrete-time signals are often referred to as time series in other fields. Continuous-time signals are often referred to as continuous signals even when the signal functions are not continuous, such as in a square-wave signal. Another categorization is signals which are “discrete-valued” and “continuous-valued”. Particularly in digital signal processing a digital signal is sometimes defined as a sequence of discrete values, that may or may not be derived from an underlying continuous-valued physical process. In other contexts, digital signals are defined as the continuous-time waveform signals in a digital system, representing a bit-stream. In the first case, a signal that is generated by means of a digital modulation method may be considered as converted to an analog signal, while it may be considered as a digital signal in the second case.

“Trailer” generally refers to an unpowered vehicle towed by another vehicle. For instance, a trailer can include a nonautomotive vehicle designed to be hauled by road, such as a vehicle configured to transport cargo, to serve as a temporary (or permanent) dwelling, and/or acting as a temporary place of business. Some non-limiting examples of trailers include open carts, semi-trailers, boat trailers, and mobile homes, to name a just few. Typically, trailers lack a power train for propelling themselves over long distances and require another powered vehicle to move them. However, trailers may include a power source, such as a battery or generator, for powering auxiliary equipment.

“Transceiver” generally refers to a device that includes both a transmitter and a receiver that share common circuitry and/or a single housing. Transceivers are typically, but not always, designed to transmit and receive electronic signals, such as analog and/or digital radio signals.

“Transmit” generally refers to causing something to be transferred, communicated, conveyed, relayed, dispatched, or forwarded. The concept may or may not include the act of conveying something from a transmitting entity to a receiving entity. For example, a transmission may be received without knowledge as to who or what transmitted it. Likewise the transmission may be sent with or without knowledge of who or what is receiving it. To “transmit” may include, but is not limited to, the act of sending or broadcasting electromagnetic energy at any suitable frequency in the electromagnetic spectrum. Transmissions may include digital signals which may define various types of binary data such as datagrams, packets and the like. A transmission may also include analog signals.

“Unicast” generally refers to a type of data transmission where data is sent from a single source to a single destination. Unicast transmissions provide a one-to-one or a direct, point-to-point communication between two specific devices. With a unicast transmission, the data is specifically addressed to the intended recipient device. A unicast transmission is in contrast to multicast and broadcast transmissions which are one-to-many transmissions.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, vans, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Vision System” generally refers to one or more devices that collect data and form one or more images by a computer and/or other electronics to determine an appropriate position and/or to “see” an object. The vision system typically, but not always, includes an imaging-system that incorporates hardware and software to generally emulate functions of an eye, such as for automatic inspection and robotic guidance. In some cases, the vision system can employ one or more video cameras, Analog-to-Digital Conversion (ADC), and Digital Signal Processing (DSP) systems. By way of a non-limiting example, the vision system can include a charge-coupled device for inputting one or more images that are passed onto a processor for image processing. A vision system is generally not limited to just the visible spectrum. Some vision systems image the environment at infrared (IR), visible, ultraviolet (UV), and/or X-ray wavelengths. In some cases, vision systems can interpret three-dimensional surfaces, such as through binocular cameras.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 system
105 virtual safety gate
110 monitored area
115 entrance
120 entryway zone
125 vehicle
130 forklift
135 human operator
140 payload
145 item
150 loading dock
155 trailer
160 dock plate
165 dock subsystem
170 vehicle subsystem
175 sensor
180 manual control
185 head scanner
190 forks
205 controller
210 sensor barrier
215 data transmission device
220 entrance status coupler
225 vehicle coupler
230 dock coupler
305 indicator
405 vehicle controller
410 entryway zone detector
415 network interface
420 plate detector
505 field
510 front end
515 rear end
520 left trailer field
525 right trailer field
530 central field
535 rear field
540 front field
605 forward arrow
705 reverse arrow
800 flowchart
805 stage
810 stage
815 stage
820 stage
825 stage
900 flowchart
905 stage
910 stage
915 stage
920 stage
925 stage
930 stage
935 stage
1000 flowchart
1005 stage
1010 stage
1015 stage
1020 stage
1025 stage
1030 stage
1035 stage
1040 stage
1100 flowchart
1105 stage
1110 stage
1115 stage
1120 stage
1125 stage
1130 stage
1135 stage
1140 stage
1200 flowchart
1205 stage
1210 stage
1215 stage
1220 stage
1225 stage
1230 stage
1235 stage
1240 stage
1300 flowchart
1305 stage
1310 stage
1315 stage
1320 stage
1325 stage
1330 stage
1335 stage
1340 stage
1345 stage
1400 flowchart
1405 stage
1410 stage
1415 stage
1420 stage
1425 stage
1430 stage
1435 stage
1440 stage
1445 stage
1450 stage
1500 logic architecture
1505 entryway signal gate
1510 timer
1515 trailer wall signal gate
1520 counter
1525 safety signal gate
1530 latch
1535 preliminary safety condition gate
1540 primary safety condition gate
1545 secondary safety condition gate
2200 logic architecture
2205 automated reset gate
2210 timer
2215 manual reset gate

What is claimed is:

1. A system, comprising:
an entrance sensor configured to detect movement through an entrance;
a safety controller operatively coupled to the entrance sensor;
an entrance status coupler operatively coupled to the safety controller;
a vehicle controller configured to control a vehicle;
a vehicle coupler operatively coupled to the vehicle controller;
an entryway zone detector operatively coupled to the vehicle controller;
wherein the entryway zone detector is configured to detect an entryway zone at the entrance;
wherein the entrance status coupler is positioned along a travel path of the vehicle towards the entrance to unicast communicate with the vehicle coupler a status of the entrance senor;
wherein the entrance status coupler is configured to communicate a safe to enter status to the vehicle coupler when the entrance sensor does not detect anything; and
wherein the vehicle controller is configured to stop the vehicle when the entryway zone is detected with the entryway zone detector and the safe to enter status is absent.

2. The system of claim 1, further comprising:
a manual control operatively coupled to the safety controller; and
wherein the manual control is configured to reset the safety controller.

3. The system of claim 2, wherein the vehicle controller is configured to resume moving the vehicle towards the entrance when the manual control resets the status of the entrance sensor.

4. The system of claim 1, further comprising:
the vehicle;
wherein the vehicle is autonomously controlled;
wherein the vehicle is configured to move one or more items through the entrance;
wherein the vehicle positions the items at loading position to fit through the entrance;
wherein the vehicle has a first scanner located on the vehicle where the items at the loading position block the view of the first scanner; and
wherein the vehicle controller is configured to monitor for the entryway zone with the entryway zone detector when the vehicle is in the loading position.

5. The system of claim 4, wherein:
the vehicle is an autonomous forklift;
the forklift has one or more forks configured to carry the items;
the entryway zone has a dock plate;
the entryway zone detector includes a plate detector;
the plate detector is configured to sense the dock plate; and
the plate detector is configured to monitor for the dock plate when the forks are below a lift height limit.

6. The system of claim 5, wherein the vehicle controller is configured to stop of the forklift when the plate detector detects the dock plate and the safe to enter status is missing.

7. The system of claim 5, further comprising:
a second scanner operatively coupled to the vehicle controller; and
wherein the second scanner is configured to detect one or more inner sidewalls of a trailer.

8. The system of claim 1, wherein:
the entrance sensor is disposed on opposing sides of the entrance; and
the entrance sensor includes a light curtain.

9. The system of claim 1, wherein the entrance status coupler is an optical coupler.

10. A system, comprising:
an entrance sensor is positioned at a doorway of a loading dock;
wherein the loading dock has a dock plate at the doorway;
a safety controller operatively coupled to the entrance sensor;
a loading dock coupler operatively coupled to the safety controller;
wherein the loading dock coupler is located before the doorway of the loading dock;
a vehicle controller configured to control a forklift;
a forklift coupler operatively coupled to the vehicle controller;
wherein the loading dock coupler is configured to communicate with the forklift coupler when the forklift coupler is positioned to face the loading dock coupler;
a plate detector operatively coupled to the vehicle controller;
wherein the vehicle controller of the forklift is configured to latch to a safe to enter status upon receiving a safe to enter status signal from the loading dock coupler; and
wherein the vehicle controller is configured to permit the forklift to enter the doorway of the loading dock when the plate detector detects the dock plate and the safe to enter status is present.

11. The system of claim 10, further comprising:
wherein the forklift has one or more forks configured to carry one or more items;
wherein the items on the forks form a payload;
a safety scanner located on the forklift where the payload obstructs the safety scanner when the forks are at a loading position; and
wherein the plate detector is configured to monitor for the dock plate when the forks at or are below the loading position.

12. The system of claim 10, further comprising:
a reset button operatively coupled to the safety controller; and
wherein the entrance sensor is configured to reset to the safe to enter status upon the reset button being actuated.

13. The system of claim 10, further comprising:
a head scanner mounted to the forklift; and
wherein the head scanner is configured to detect inner sidewalls of a trailer.

14. The system of claim 10, wherein the entrance sensor includes a light curtain.

15. The system of claim 10, wherein the vehicle controller is configured to stop of the forklift when the plate detector detects the dock plate and the safe to enter status is missing.

16. The system of claim 10, wherein:
the dock plate is composed of ferromagnetic material; and
the plate detector is a magnetic sensor.

17. A method, comprising:
monitoring an entrance for entry with an entrance sensor;
transmitting a safe to enter status from an entrance status coupler when the entrance sensor does not detect entry;
receiving the safe to enter status with a vehicle coupler mounted to a vehicle;
moving the vehicle towards the entrance;
detecting an entryway zone of the entrance with an entryway zone detector mounted on the vehicle; and
advancing the vehicle through the entrance upon the receiving the safe to enter status and the detecting the entryway zone.

18. The method of claim 17, further comprising:
ceasing transmission of the safe to enter status when the entrance sensor detects entry; and
stopping the vehicle upon detection of the ceasing transmission of the safe to enter status with the vehicle coupler and the detecting the entryway zone.

19. The method of claim 18, further comprising:
manually resetting the entrance sensor to resume transmission of the safe to enter status from the entrance status coupler.

20. The method of claim 17, further comprising:
wherein the vehicle has a safety scanner; and
initiating the detecting the entryway zone when the safety scanner is obstructed.

21. The method of claim 17, wherein:
the entryway zone has a dock plate;
the vehicle is a forklift;
the entryway zone detector includes a plate detector; and
the detecting the entryway zone includes detecting the dock plate with the plate detector.
